(19) United States
(12) Patent Application Publication
(10) Pub. No.: US 2016/0134888 A1
(43) Pub. Date: May 12, 2016

(54) VIDEO ENCODING APPARATUS, VIDEO ENCODING METHOD, VIDEO DECODING APPARATUS, AND VIDEO DECODING METHOD

(71) Applicant: FUJITSU LIMITED, Kawasaki-shi (JP)

(72) Inventors: Kimihiko KAZUI, Kawasaki (JP); Satoshi SHIMADA, Kawasaki (JP); Guillaume Denis Christian Barroux, Kawasaki (JP)

(73) Assignee: FUJITSU LIMITED, Kawasaki-shi (JP)

(21) Appl. No.: 14/996,931

(22) Filed: Jan. 15, 2016

Related U.S. Application Data
(63) Continuation of application No. PCT/JP2013/069332, filed on Jul. 16, 2013.

(51) Int. Cl. H04N 19/537; H04N 19/91; H04N 19/44; H04N 19/423

(52) U.S. Cl. CPC H04N 19/537; H04N 19/423; H04N 19/91; H04N 19/44

(57) ABSTRACT

A video encoding apparatus includes: a buffer memory that stores encoded field pictures; a controller that adds reference pair information to each of multiple field pictures, the reference pair information specifying a field picture to be paired when creating a frame picture; a buffer interface that generates, when inter-predictive coding is performed by using, as a coding target picture, a frame picture created by interleaving two field pictures that are not encoded, a frame picture as a reference picture by interleaving the field pictures of the pair specified with reference to the reference pair information of a stored encoded field picture; and an encoder that generates, when the coding target picture is a frame picture, encoded data by performing inter-predictive coding on the coding target picture on a frame-picture-by-frame-picture basis by use of the reference picture.

### CROSS-REFERENCE TO RELATED APPLICATION

This application is a continuation application and is based upon PCT/JP2013/069332, filed on Jul. 16, 2013, the entire contents of which are incorporated herein by reference.

### FIELD

The present invention relates, for example, to a video encoding apparatus and a video encoding method for inter-predictive coding, and a video decoding apparatus and a video decoding method for decoding a video encoded by inter-predictive coding.

### BACKGROUND

The size of video data is usually large. For this reason, devices handling video data normally encode and thereby compress the video data before transmitting the video data to a different device or storing the video data in a storage device. Widely used video coding standards are Moving Picture Experts Group phase 2 (MPEG-2), MPEG-4, and H.264 MPEG-4 Advanced Video Coding (MPEG-4 AVC/H.264) standardized by the International Standardization Organization/International Electrotechnical Commission (ISO/IEC). In addition to these, High Efficiency Video Coding (HEVC, MPEG-H/H.265) is standardized as a new coding standard (refer to, for example, JCTVC-L1003, “High Efficiency Video Coding (HEVC) text specification draft 10 (for FDIS & Consent)”, Joint Collaborative Team on Video Coding of ITU-T SG16 WP3 and ISO/IEC JTC1/SC29/WG11, January 2013).

These coding standards employ inter-predictive coding, in which a coding target picture is encoded by using information on encoded pictures, and intra-predictive coding, in which a coding target picture is encoded by using information on the coding target picture only.

In MPEG-2, pictures to be referred to by a coding target picture in inter-predictive coding (reference picture) are uniquely determined on the basis of a group of pictures (GOP) structure. In contrast, in the AVC standard and the HEVC standard, reference pictures can be determined independent of a GOP structure. Pictures encoded by source coding and thereafter decoded are stored in a decoded picture buffer (DPB) so as to be referred to by pictures to be encoded later in inter-predictive coding. Reference pictures are determined in the following two steps. In the first step, encoded (or decoded in the case of a decoding apparatus) pictures to be stored in the DPB are determined (DPB management). In the second step, multiple pictures to be used as reference pictures for a coding target picture are selected from multiple pictures stored in the DPB (establishment of a reference picture list). The operations in the two steps are different between the AVC standard and the HEVC standard (refer to, for example, Japanese Laid-open Patent Publication No. 2013-110549, and JCTVC-G196, “Modification of derivation process of motion vector information for interlace format”, Joint Collaborative Team on Video Coding of ITU-T SG16 WP3 and ISO/IEC JTC1/SC29/WG11, November 2011).

First, DPB management will be described. The AVC standard employs sliding-window-based management, in which the picture encoded most lately is preferentially stored in a DPB. When the DPB does not have enough free space, pictures are deleted from the DPB sequentially from the one encoded earliest. In addition to the sliding-window-based management, the AVC standard complementarily employs the memory management control operations (MMCO), in which one or more specified pictures among the pictures stored in the DPB are deleted.

FIG. 1 illustrates an example of a relationship of coding target pictures and a DPB for illustrating an example of sliding-window-based DPB management. In FIG. 1, the horizontal axis represents an order in which pictures are input to a video encoding apparatus.

A video 1010 includes pictures I0 and P1 to P8. The picture I0 is an I picture encoded by intra-predictive coding, and the pictures P1 to P8 are P pictures encoded by unidirectional inter-predictive coding. In this example, it is assumed that the order in which the pictures are input to the video coding device is the same as the coding order of the pictures. The arrows presented above the pictures indicate the reference relationship in the coding, and the picture at the head of each arrow is referred to by the picture at the starting point of the arrow. In the coding structure illustrated in this example, each picture corresponding to 3n (where n is an integer) in the input order preferentially refers to the pictures each corresponding to 3(n−1) or 3(n−2) in the input order. Each picture corresponding to (3n+1) in the input order preferentially refers to the pictures each corresponding to 3n or {3(n−1)+1} in the input order. Each picture corresponding to (3n+2) in the input order preferentially refers to the pictures each corresponding to (3n+1), 3n, or {3(n−1)+2} in the input order. This coding structure corresponds to temporal hierarchical coding. Through this coding, a video decoding apparatus can successfully decode pictures corresponding, for example, to 3m (where m is an integer) in the input order without decoding the pictures other than those corresponding to 3m in the input order (i.e., triple-speed play).

In this example, a DPB 1020 includes four banks (bank 0 to bank 3), and each bank stores a single picture. In FIG. 1, N/A in each bank indicates that no picture is stored in the bank. For example, at the time when the picture I0 is input, no picture is stored in any of the banks. At the time when the picture P1 is input, the picture I0 is stored in the bank 0. Subsequently, every time a picture is input to the video encoding apparatus and is encoded, the encoded picture is stored in the DPB 1020.

In the sliding-window-based management, pictures that are later in the coding order are preferentially stored in the DPB 1020. For example, to encode the picture P5, the picture I0 is deleted from the DPB, and hence the picture P6 has no possibility of referring to the picture I0.

This problem can be solved by employing MMCO, which is the other DPB management mode of the AVC. Specifically, the video encoding apparatus deletes the picture P1 from the DPB 1020 upon completion of the coding of the picture P4. The video encoding apparatus then deletes the picture P2 from the DPB 1020 upon completion of the coding of the picture P5. In this way, the video encoding apparatus can keep the picture I0 stored in the DPB 1020 at the time of starting encoding of the picture P6.

In contrast, the HEVC standard employs the reference picture set (RPS)-based DPB management. In the RPS-based DPB management, encoded pictures that are to be stored in a DPB are explicitly indicated when each picture is encoded. In the RPS-based management, when a picture is stored in the DPB for a certain time period, the information that the picture is stored in the DPB needs to be continuously indicated in an explicit manner for all of the pictures encoded in the period.

FIG. 2 is a diagram illustrating an example of a relationship of coding target pictures and a DPB for illustrating an example of RPS-based management. In FIG. 2, the horizontal axis represents an order in which pictures are input to a video encoding apparatus.

A video 1110 includes pictures I0 and P1 to P8. The picture I0 is an I picture to be encoded by intra-predictive coding, and the pictures P1 to P8 are P pictures to be encoded by unidirectional inter-predictive coding. In this example, it is assumed that the order in which the pictures are input to the video encoding apparatus is the same as the coding order of the pictures. The arrows provided above the pictures indicate the reference relationship in the coding, and the picture at the head of each arrow is referred to by the picture at the starting point of the arrow.

A list 1120 is a list of picture order count (POC) values (RPS) each of which is to be added to the encoded data on each picture and indicates the picture to be kept stored in the DPB. A POC value is a unique value for the corresponding picture in a manner to increase according to the input order (i.e., the display order) of the pictures, and is added to the coding data on the picture. For example, the RPS of the picture P6 includes the POC values of the pictures I0, P3, P4, and P5. The POC values of these pictures need to be included in the RPS of the picture encoded prior to the picture P6. For example, when the RPS of the picture P5 does not include the POC value of the picture I0, the picture I0 is deleted from the DPB 1130 at the time of starting encoding the picture P6. In this case, it is not possible for the picture P6 to refer to the picture I0 although the RPS of the picture P6 includes the POC value of the picture I0.

In this example, the DPB 1130 includes four banks as the DPB 1020. In FIG. 2, the pictures stored in the respective banks of the DPB 1130 when each picture is input are presented. In this example, since the picture I0 is stored in the bank 0 at the time of encoding the picture P6, which is different from the DPB 1020, it is possible for the picture P6 to refer to the picture I0.

As described above, a video encoding apparatus, by employing the RPS-based management, is capable of implementing the functions implemented by sliding-window-based management and MMCO. Hence, employing RPS-based management facilitates the process of DPB management.

Next, establishment of reference picture lists will be described. In the AVC standard and the HEVC standard, two reference picture lists L0 and L1 are defined. The list L0 corresponds forward reference pictures of the MPEG-2 standard, and the list L1 corresponds backward reference pictures. Note that, in the AVC standard and the HEVC standard, the list L1 can include reference pictures that are earlier in the input order (i.e., the display order) (i.e., have smaller POC values) than a coding target picture. Each of the list L0 and the list L1 may include multiple reference pictures. A P picture has only the list L0, and a B picture may have both the list L0 and the list L1. Each of the list L0 and the list L1 includes the picture(s) selected from the multiple reference pictures stored in a DPB. The list L0 and the list L1 are created for each picture to be encoded (or decoded in the case of a video decoding apparatus). For each block of a picture to be encoded by inter-predictive coding, a reference picture to be used for the inter-predictive coding is selected from the reference pictures included in the corresponding one(s) of the list L0 and the list L1. In the case of the HEVC standard, parameters RefIdxL0 and RefIdxL1 are defined for each prediction unit (PU), which is a unit for inter-predictive coding. Each of these parameters indicates the number of a corresponding reference picture in the order in the corresponding list. In the following description, an L0-direction reference picture and an L1-direction reference picture of each PU are denoted respectively by L0[RefIdxL0] and L1[RefIdxL1].

The AVC standard and the HEVC standard employ different methods for determining default L0 and L1. The AVC standard uses different parameters for determining default L0 and L1 when a coding target picture is a P picture and when a coding target picture is a B picture. When a coding target picture is a P picture, reference pictures each having a smaller FrameNum value than that of the coding target picture are stored in L0. In this case, the reference pictures are stored in the L0 sequentially from the one having the smallest difference between the FrameNum value of the coding target picture and the FrameNum value of the reference picture. FrameNum is a parameter added to each picture and is incremented by one as the number in the coding order of the pictures increases. There is a requirement for field pictures in which the two field pictures of a field pair forming a single frame have the same FrameNum. For this reason, the two field pictures of each field pair are always consecutive in the coding order.

In contrast, when a coding target picture is a B picture, reference pictures each having a smaller POC value than that of the coding target picture are stored in L0. In this case, the reference pictures are stored in L0 sequentially from the reference picture having the smallest difference between the POC value of the coding target picture and the POC value of the reference picture. The reference pictures each having a larger POC value than that of the coding target picture are stored in L1. In this case, the reference pictures are stored in L1 sequentially from the reference picture having the smallest difference between the POC value of the coding target picture and the POC value of the reference picture.

The HEVC standard disestablishes using FrameNum. Instead, the HEVC standard determines reference pictures to be stored in L0 and L1 by use of POC values in a similar method as that for determining reference pictures to be stored in L0 and L1 for a B picture in the AVC standard. Hence, in the HEVC standard, the two field pictures of each field pair do not need to be consecutive in the coding order.

In both the AVC standard and the HEVC standard, default L0 and L1 created in the above-described method are rewritable. Specifically, it is possible to reduce the list sizes of L0 and L1 (i.e., to use only some of the pictures that are stored in the DPB and are possible to be referred to in inter-predictive coding) and to change the order of the reference pictures in the list. By changing the order of the reference pictures in the list, the video encoding apparatus can move reference pictures likely to be referred to at high frequencies in each PU, to the top of each list. This reduces the numbers of bits of RedIdxL0 and RefIdxL1 in variable-length coding (entropy coding), consequently increasing coding efficiency. Methods for notifying a needed parameter are similar in the AVC standard and the HEVC standard.

### SUMMARY

The HEVC standard is used for videos generated in an interlace method (each referred to simply as an interlaced video below). An interlaced video will be described with reference to FIG. 3.

Pictures 1210 to 1213 are frame pictures included in a video generated by a progressive method (referred to simply as a progressive video below). An interlaced video is obtained by alternately extracting a top-field picture and a bottom-field picture from the frame pictures of the progressive video, the top-field picture including only even-numbered (0, 2, 4, . . . ) lines of the corresponding frame picture, the bottom-field picture only including odd-numbered (1, 3, 5, . . . ) lines of the corresponding frame picture. The number of lines in the vertical direction in a field picture is half the number of lines in the vertical direction in a frame picture. In FIG. 3, pictures 1220 and 1222 are top-field pictures, and pictures 1221 and 1223 are bottom-field pictures.

The vertical resolution of the interlaced video is half the vertical resolution of the progressive video. The perceptive spatial resolution of the human sense of sight usually decreases in the case of watching a fast-moving video. By taking advantage of this aspect, it is possible to reduce the size of data of an interlaced video without greatly reducing the image quality perceived by humans.

When an interlaced video is encoded in the AVC standard, a video encoding apparatus can switch field-picture-based coding (referred to as field coding) and field-pair-based coding (referred to as frame coding) for each field pair. A field pair in this case includes a top-field picture and a bottom-field picture that are consecutive in time.

In frame coding, the video encoding apparatus creates a single frame picture by interleaving lines of a captured top-field picture and lines of a captured bottom-field picture, and encodes the frame picture. In this case, the time point at which the lines of the top-field picture are captured is different from that at which the lines of the bottom-field picture are captured. For this reason, field coding is usually employed when objects included in the pictures move a lot whereas frame coding is employed when objects included in the pictures move little.

In contrast, in the HEVC standard, field coding and frame coding are switched for each sequence instead of for each field pair. A sequence is a group of multiple pictures that are consecutive in the coding order starting from the intra-predictive coding picture serving as a random access (redrawing start) point.

For each sequence to be encoded by field coding, the video encoding apparatus performs frame coding by assuming that each field picture is a frame picture having lines half the number of lines in the vertical direction in a frame picture and having a frame rate twice the frame rate of a frame picture. No special coding for interlaced videos as employed in the AVC standard and other standards is performed and the parity (top or bottom) of each field picture is not used in the coding. In the HEVC standard, inter-predictive coding is not performed on pictures belonging to different sequences. In other words, all of the pictures stored in the DPB are always either field pictures or frame pictures. In the RPS-based management, the same control is performed for both field pictures and frame pictures.

In the switching between field coding and frame coding for each sequence in the HEVC standard, an intra-predictive coding picture inevitably exists at the boundary between sequences where the switching takes place, consequently reducing coding efficiency. In view of such reduction, field coding and frame coding are preferably switched for each field pair as in the AVC standard. However, it is not possible to perform the RPS-based management in the HEVC standard when both field coding and frame coding are employed.

A video encoding apparatus and a video decoding apparatus according to an aspect of the present invention always use field pictures as pictures stored in a DPB in order to perform the same operation according to RPS-based management irrespective of type (field or frame) of a coding target picture. Similarly, RPS information on a coding target picture is always on a field-picture-by-field-picture basis. The RPS information is an example of reference picture information.

Reference pair information is defined for each picture as a newly added picture parameter, the reference pair information indicating the two field pictures to be paired when being referred to by a frame picture. Specifically, the reference pair information indicates a pair of a single top-field picture and a single bottom-field picture stored in the DPB. In the AVC standard, a pair of a top-field picture and a bottom-field picture may always be a pair of field pictures that are consecutive in the display order, i.e., a pair of a top-field picture corresponding to 2t (where t is an integer) in the input order and a bottom-field picture corresponding to (2t+1) in the input order. In this aspect, however, the video encoding apparatus forms, by use of reference pair information, a single frame picture by combining a top-field picture and a bottom-field picture that are apart from each other in terms of time, and enables a coding target picture to refer to the frame picture. This configuration further increases coding efficiency.

According to one embodiment, a video encoding apparatus that performs inter-predictive coding on multiple field pictures included in a video is provided. The video encoding apparatus includes: a buffer memory that stores an encoded field picture among the multiple field pictures; a control unit that adds reference pair information to each of the multiple field pictures when a frame picture is to be created by interleaving two field pictures forming a pair, the reference pair information specifying a different field picture to form the pair; a buffer interface unit that generates, when inter-predictive coding is performed by using, as a coding target picture, a frame picture created by interleaving two field pictures that are not encoded among the multiple field pictures, a frame picture as a reference picture by interleaving the field pictures of the pair specified with reference to the reference pair information of an encoded field picture stored in the buffer memory; a coding unit that generates, when the coding target picture is a frame picture, encoded data by performing inter-predictive coding on the coding target picture on a frame-picture-by-frame-picture basis by use of the reference picture; and an entropy encoding unit that performs entropy coding on the encoded data and the reference pair information to generate encoded video data including the entropy-encoded reference pair information.

According to another embodiment, a video decoding apparatus that decodes an encoded video including a plurality of field pictures which are inter-predictive encoded is provided. The video decoding apparatus includes: an entropy decoding unit that decodes entropy-encoded data on a decoding target picture and reference pair information specifying, for each of the plurality of field pictures, when a frame picture is to be created by interleaving two field pictures forming a pair, a different field picture to form the pair; a buffer memory that stores a decoded field picture among the plurality of field pictures; a reference picture management unit that determines, when the decoding target picture is a frame picture created by interleaving two field pictures that are not decoded among the plurality of field pictures, two decoded field pictures to be used for generating a reference picture, with reference to the reference pair information; a buffer interface unit that generates a frame picture as the reference picture, when inter-predictive decoding is performed by using, as the decoding target picture, a frame picture created by interleaving two field pictures that are not decoded among the plurality of field pictures, by interleaving two decoded field pictures determined on the basis of the reference pair information from among decoded field pictures stored in the buffer memory; and a decoding unit that decodes, when the decoding target picture is a frame picture, the decoding target picture by performing inter-predictive decoding on the encoded data on the decoding target picture on a frame-picture-by-frame-picture basis by use of the reference picture.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating sliding-window-based DPB management.

FIG. 2 is a diagram illustrating RPS-based DPB management.

FIG. 3 is a diagram illustrating an interlaced video.

FIG. 4 is a diagram illustrating a schematic configuration of a video encoding apparatus according to a first embodiment.

FIG. 5 is a diagram illustrating a schematic configuration of a video decoding apparatus according to the first embodiment.

FIG. 6 is a diagram illustrating an example of a coding unit according to the first embodiment.

FIG. 7 is a diagram illustrating an example of coding structure determination according to the first embodiment.

FIG. 8 is a diagram illustrating an example of DPB management according to the first embodiment.

FIG. 9 is a diagram illustrating data structures of an embedded memory in a buffer interface unit and a frame buffer according to the first embodiment.

FIG. 10 is a diagram illustrating a structure of control data exchanged among a control unit, a buffer interface unit, and a source encoding unit according to the first embodiment.

FIG. 11 is a diagram illustrating a structure and parameters of a bit stream according to the first embodiment.

FIG. 12 is an operational flowchart of a video encoding process according to the first embodiment.

FIG. 13 is an operational flowchart of a video decoding process according to the first embodiment.

FIG. 14 is a diagram illustrating an example of a coding unit according to a second embodiment.

FIG. 15 is a diagram illustrating an example of coding structure determination according to the second embodiment.

FIG. 16 is a diagram illustrating an example of DPB management according to the second embodiment.

FIG. 17 is a diagram illustrating a configuration of a computer configured to operate, when a computer program implementing functions of units of the video encoding apparatus or the video decoding apparatus according to any one of the embodiments and modified examples of the embodiments is executed, as the video encoding apparatus or the video decoding apparatus.

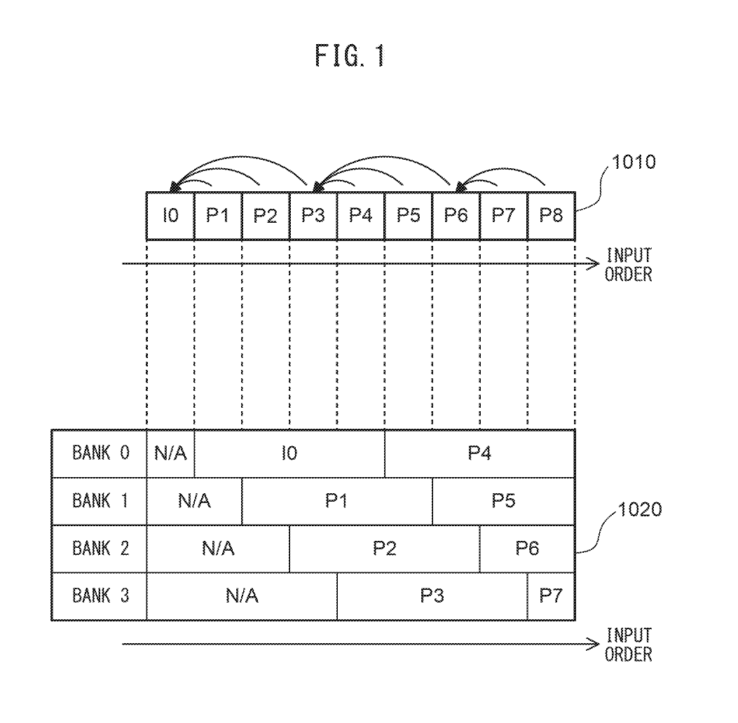

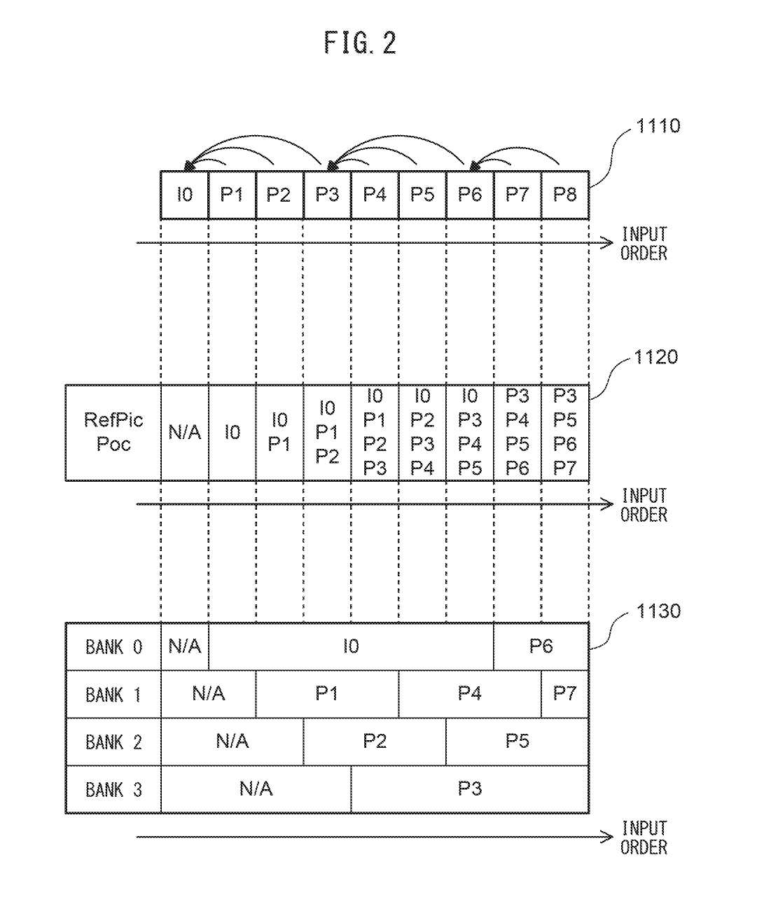

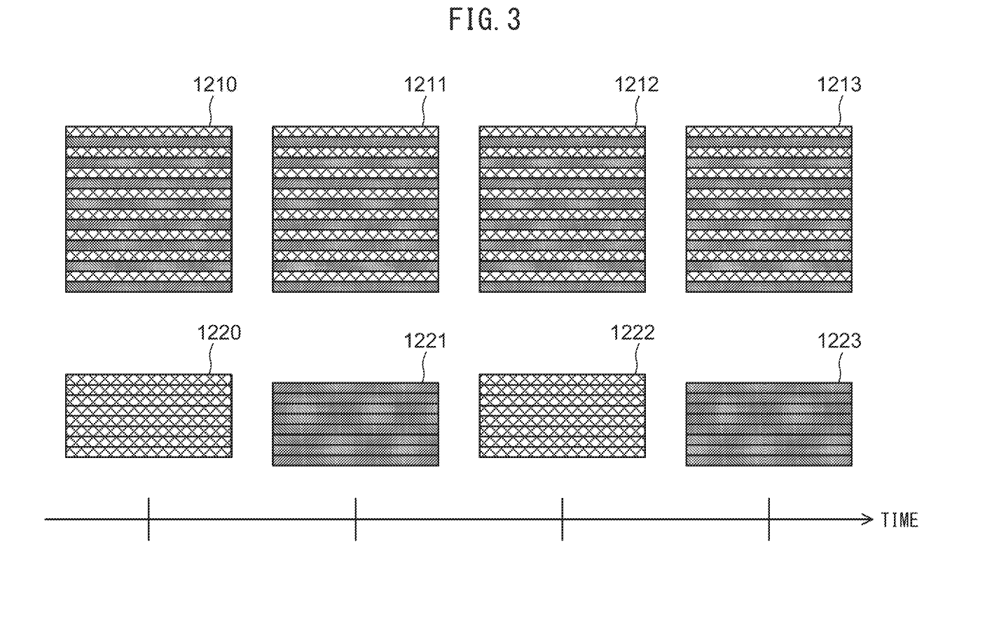

### DESCRIPTION OF EMBODIMENTS

A video encoding apparatus according to a first embodiment will be described below with reference to the drawings. The video encoding apparatus encodes an interlaced video by intra-predictive coding and inter-predictive coding and outputs encoded video data.

Pictures included in a video signal may be based on a color video or a monochrome video. A coding target interlaced video may be of top filed first, in which a top field is earlier than a bottom field in the input (display) order in a field pair. Alternatively, a coding target interlaced video may be based on bottom field first, in which a bottom field is earlier than a top field in the input (display) order in a field pair. When a coding target interlaced video is of bottom field first, a top filed and a bottom field only need to be switched in the following description.

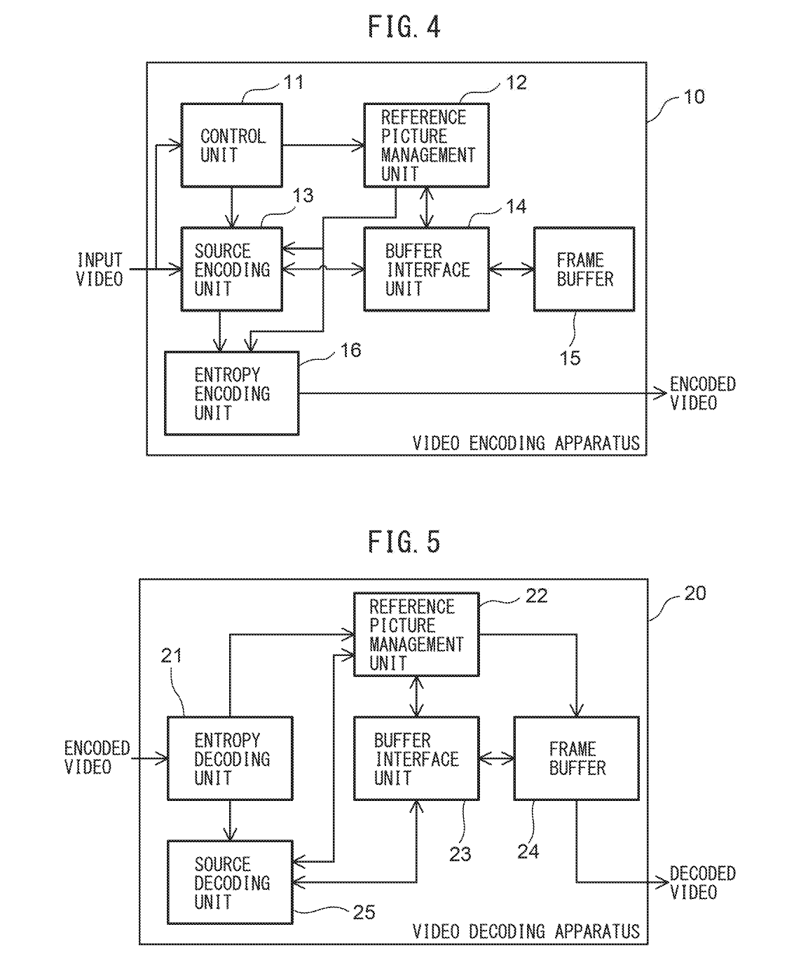

FIG. 4 is a diagram illustrating a schematic configuration of the video encoding apparatus according to the first embodiment. A video encoding apparatus 10 includes a control unit 11, a reference picture management unit 12, a source encoding unit 13, a buffer interface unit 14, a frame buffer 15, and an entropy encoding unit 16. These units of the video encoding apparatus 10 are provided in the video encoding apparatus 10 as separate circuits. Alternatively, the units of the video encoding apparatus 10 may be provided in the video encoding apparatus 10 as a single integrated circuit in which circuits implementing the functions of the units are integrated. Further alternatively, the units of the video encoding apparatus 10 may be functional modules implemented by a computer program executed on a processor included in the video encoding apparatus 10.

The control unit 11 determines the coding unit structure and a coding mode for each picture in the coding unit, on the basis of a control signal input from an external unit (not illustrated) and the characteristics of an input video, for example, the degree of movement of the objects captured in pictures. The coding unit structure is to be described later. The coding mode is inter-predictive coding or intra-predictive coding. The control unit 11 determines the coding order of the pictures, the reference relationship, and the type (frame or field) of each picture on the basis of the control signal and the characteristics of the input video. The control unit 11 adds reference pair information to each field picture on the basis of the corresponding coding unit structure. The control unit 11 notifies the reference picture management unit 12, the source encoding unit 13, and the entropy encoding unit 16 of the reference pair information. The control unit 11 notifies the reference picture management unit 12 and the source encoding unit 13 of the coding unit structure, the coding mode for the coding target picture, the reference relationship, and the picture type.

The reference picture management unit 12 manages the frame buffer 15, which is an example of a DPB. The reference picture management unit 12 creates reference picture information specifying field pictures usable as a reference picture among the encoded field pictures stored in the frame buffer 15, and notifies the source encoding unit 13 of the reference picture information. In other words, the reference picture management unit 12 notifies the source encoding unit 13 of the bank numbers corresponding to the reference pictures and local decoded pictures in the DPB. A local decoded picture is part of a picture obtained by decoding a part that has been encoded by source coding in the coding target picture. The details of the processes carried out by the control unit 11 and the reference picture management unit 12 and reference pair information are to be described later.

The source encoding unit 13 performs source coding (information source coding) on each picture included in the input video. Specifically, the source encoding unit 13 generates a prediction block for each block on the basis of a reference picture or a local decoded picture stored in the frame buffer 15 in accordance with the coding mode selected for each picture. In the generation, the source encoding unit 13 outputs a request for reading a reference picture or a local decoded picture to the buffer interface unit 14, and receives the value of each pixel of the reference picture or the local decoded picture from the frame buffer 15 via the buffer interface unit 14.

For example, the source encoding unit 13 calculates a motion vector when the block is to be encoded by inter-predictive coding in the forward prediction mode or the backward prediction mode. The motion vector is calculated, for example, through execution of block matching between the reference picture obtained from the frame buffer 15 and the block. The source encoding unit 13 carries out motion compensation on the reference picture by use of the motion vector. The source encoding unit 13 generates a motion-compensated prediction block for inter-predictive coding. Motion compensation is a process for moving the position of an area most similar to the block in the reference picture in such a way as to cancel the deviation, from the block, of the position of the area most similar to the block in the reference picture, the deviation being expressed by the motion vector.

When the coding target block is encoded by inter-predictive coding in the bidirectional prediction mode, the source encoding unit 13 carries out motion compensation so as to compensate for each area in the reference picture identified by each of two respective motion vectors, by use of a corresponding motion vector. The source encoding unit 13 then generates a prediction block by averaging the pixel values of each two corresponding pixels of the two compensated images obtained through the motion compensation. Alternatively, the source encoding unit 13 may generate a prediction block by calculating a weighted average of the pixel values of the two compensated images by multiplying each of the pixel values by a larger weighting factor when the time difference between the reference picture and the coding target picture is shorter.

When the coding target block is to be encoded by intra-predictive coding, the source encoding unit 13 generates a prediction block from a block included in the local decoded picture and being adjacent to the coding target block. The source encoding unit 13 calculates, for each block, the difference between the block and the prediction block. The source encoding unit 13 sets the difference value obtained through the calculation and corresponding to each pixel in the block, as a prediction error signal.

The source encoding unit 13 obtains a prediction error transform coefficient by orthogonally transforming each prediction error signal of the block. The source encoding unit 13 may perform, for example, discrete cosine transform (DCT) as an orthogonal transform process.

The source encoding unit 13 calculates the quantized coefficient of prediction error transform coefficient by quantizing the prediction error transform coefficient. This quantization process is a process of representing the signal values included in a certain interval by a single signal value. The certain interval is referred to as quantization width. For example, the source encoding unit 13 quantizes the prediction error transform coefficient by rounding down the prediction error transform coefficient at a predetermined number of low-order bits corresponding to the quantization width. The source encoding unit 13 outputs, as coding data, the quantized prediction error transform coefficients and coding parameters including the motion vectors, to the entropy encoding unit 16.

The source encoding unit 13 generates, from the quantized prediction error transform coefficients of the block, a local decoded picture and a reference picture to be referred to for encoding blocks later than the block in the coding order. For this generation, the source encoding unit 13 inversely quantizes the quantized prediction error transform coefficient by multiplying the quantized prediction error transform coefficient by the predetermined number corresponding to the quantization width. Through this inverse quantization, the prediction error transform coefficient of the block is restored. Subsequently, the source encoding unit 13 performs an inverse orthogonal transform process on the prediction error transform coefficient. Through the inverse quantization and inverse orthogonal transform on each quantized signal, a prediction error signal having information equivalent to the corresponding prediction error signal before the coding is regenerated.

The source encoding unit 13 adds to the value of each pixel of the prediction block, the regenerated prediction error signal corresponding to the pixel. The source encoding unit 13 generates a local decoded picture to be used to generate a prediction block for each block to be encoded later, by carrying out these processes for each block. Every time a local decoded picture of a block is generated, the source encoding unit 13 outputs the local decoded picture with a write request, to the buffer interface unit 14.

In response to the request for reading a reference picture or a local decoded picture, the buffer interface unit 14 reads the value of each pixel of the reference picture or the local decoded picture from the frame buffer 15 and outputs the value of each pixel to the source encoding unit 13. When the reference picture is a frame picture, the buffer interface unit 14 reads, from the frame buffer 15, the value of each pixel of each of two field pictures identified on the basis of reference pair information and interleaves the two field pictures, thereby generating a frame picture.

In response to a request for writing a local decoded picture, the buffer interface unit 14 writes the local decoded picture in the frame buffer 15. In this process, the buffer interface unit 14 may combine local decoded pictures, for example, by writing the local decoded pictures in the coding order in the frame buffer 15. By combining the local decoded pictures corresponding to all the blocks of the coding target picture, a reference picture is regenerated.

The frame buffer 15 has a memory capacity enough to store multiple field pictures possible to be used as reference pictures. The frame buffer 15 includes multiple banks and stores either a reference picture or local decoded pictures in each bank.

The entropy encoding unit 16 generates an encoded picture by performing entropy coding on the quantized transform coefficient, coding parameters, such as the motion vector, and header information including the reference pair information. The entropy encoding unit 16 outputs the encoded picture as a bit stream.

FIG. 5 is a diagram illustrating a schematic configuration of the video decoding apparatus according to the first embodiment. A video decoding apparatus 20 includes an entropy decoding unit 21, a reference picture management unit 22, a buffer interface unit 23, a frame buffer 24, and a source decoding unit 25. These units of the video decoding apparatus 20 are provided in the video decoding apparatus 20 as separate circuits. Alternatively, the units of the video decoding apparatus 20 may be provided in the video decoding apparatus 20 as a single integrated circuit in which circuits implementing the functions of the units are integrated. Further alternatively, the units of the video decoding apparatus 20 may be functional modules implemented by a computer program executed on a processor included in the video decoding apparatus 20.

The entropy decoding unit 21 decodes quantized transform coefficient, coding parameters, such as a motion vector, and reference pair information by performing entropy decoding on a bit stream of an encoded video. The entropy decoding unit 21 outputs the quantized transform coefficient and the coding parameters to the source decoding unit 25. In addition, the entropy decoding unit 21 outputs parameters needed for DPB management such as reference pair information among the coding parameters, to the reference picture management unit 22.

The reference picture management unit 22 manages the frame buffer 24, which is an example of a DPB. The reference picture management unit 22 stores a picture on the basis of the coding parameters transmitted by the entropy decoding unit 21, in the frame buffer 24, and determines a reference picture to be referred to in the decoding of a picture. When a decoding target picture is a frame picture, the reference picture management unit 22 determines the two field pictures to be used for creating a reference picture with reference to the reference pair information. The reference picture management unit 22 notifies the source decoding unit 25 of the bank numbers of the reference picture and a decoded picture.

In response to a request for reading a reference picture from the source decoding unit 25, the buffer interface unit 23 reads the value of each pixel of the requested reference picture from the frame buffer 24 and outputs the value of each pixel to the source decoding unit 25. When the reference picture is a frame picture, the buffer interface unit 23 reads, from the frame buffer 24, the value of each pixel of each of the two field pictures identified on the basis of the reference pair information, and generates a frame picture by interleaving the two field pictures. In response to a request for writing a decoded picture from the source decoding unit 25, the buffer interface unit 23 writes the value of each pixel of the received decoded picture in the frame buffer 24.

The frame buffer 24 includes multiple banks and stores either a reference picture or local decoded pictures in each bank.

The source decoding unit 25 performs source decoding on each block of a decoding target picture notified by the entropy decoding unit 21, by use of quantized prediction error transform coefficients, coding parameters, and a motion vector. Specifically, the source decoding unit 25 performs inverse quantization on each quantized prediction error transform coefficient by multiplying the quantized prediction error transform coefficient by a predetermined number corresponding to the quantization width. Through this inverse quantization, the prediction error transform coefficient of the decoding target block is restored. After the restoring, the source decoding unit 25 performs an inverse orthogonal transform process on the prediction error transform coefficient. Through the inverse quantization and the inverse orthogonal transform on the quantized signal, a prediction error signal is regenerated.

The source decoding unit 25 notifies the buffer interface unit 23 of a request for reading the value of each pixel of a reference picture or a decoded picture. The source decoding unit 25 receives the value of each pixel of the reference picture or the decoded picture from the buffer interface unit 23. The source decoding unit 25 generates a prediction block on the basis of the reference picture or the decoded picture.

The source decoding unit 25 adds to the value of each pixel of the prediction block, the regenerated prediction error signal corresponding to the pixel. The source decoding unit 25 decodes each block by carrying out these processes on each block. When a block is one encoded by inter-predictive coding, a prediction block is created by use of a decoded picture and a decoded motion vector. The source decoding unit 25 decodes a picture, for example, by combining the blocks in the coding order. The decoded picture is output to an external device to be displayed. The source decoding unit 25 outputs the decoded picture to the buffer interface unit 23 together with a write request, in order to enable the use of the decoded picture for generating a prediction block for a block that is not decoded in the decoding target picture or generating a prediction block for any subsequent picture.

Next, details of operations of the video encoding apparatus 10 and the video decoding apparatus 20 for DPB management according to the first embodiment are described. Since the video encoding apparatus 10 and the video decoding apparatus 20 perform substantially the same operation for DPB management, description of the operation of the video decoding apparatus 20 is omitted except for the respects in which the video encoding apparatus 10 and the video decoding apparatus 20 perform different operations.

First, operation of the control unit 11 of the video encoding apparatus 10 will be described in detail. First, definitions of the following terms are given.
“Layer” indicates the layer level of a picture in temporal hierarchical coding. In the HEVC standard, a parameter NuhTemporalIdPlus1 included in a NAL unit header indicates the layer level (0, 1, 2, . . . ) of a picture. In hierarchical coding, the reference relationship is limited so that a picture having a layer level of N (where N is an integer) is encoded by referring only to one or more pictures having a layer level of N or lower. The video decoding apparatus 20 creates a sub-stream obtained by extracting only encoded pictures each having a layer level of N or lower from a bit stream having the maximum layer level of M (where M is an integer not smaller than one and N<M) and successfully decodes all the encoded pictures in the sub-stream. Coding based on a general group-of-picture (GOP) structure including I pictures (intra pictures), P pictures (forward reference pictures), and B pictures (bidirectional reference pictures) used in the MPEG-2 standard corresponds to temporal hierarchical coding having the maximum layer level of one. In other words, even when the B pictures (corresponding to the layer level one) always being non-reference pictures are eliminated from the bit stream, the video decoding apparatus 20 is capable of successfully decoding the remaining I pictures and P pictures (corresponding to the layer level zero).
“Coding unit” is a set of pictures including the pictures from the picture having a layer level of zero to the picture immediately prior to the next picture having a layer level of zero in the coding order. However, when two pictures having a layer level of zero are consecutive and are included in the same field pair, the two pictures are included in the same coding unit.

In the GOP in the MPEG-2 standard, a coding unit is a set of pictures starting from an I picture or a P picture and including multiple B pictures that are later in the coding order and earlier in the display order than the I picture or the P picture. Assume that the number of B pictures between the I picture or the P picture and the next I picture or P picture in the coding order is L, the number of pictures included in the coding unit is (L+1). In temporal hierarchical coding, the number of pictures included in a coding unit is usually (2^{M}). Here, M denotes the maximum layer level, and it is assumed that pictures having the same layer level are not consecutive in the coding order. The following description is based on this assumption.

In the first embodiment, the control unit 11 of the video encoding apparatus 10 determines a coding unit structure by use of the maximum layer number M input from an external device and a motion vector of each picture (to be described later). The video decoding unit 20 determines the coding unit structure on the basis of the parameters of the bit stream.

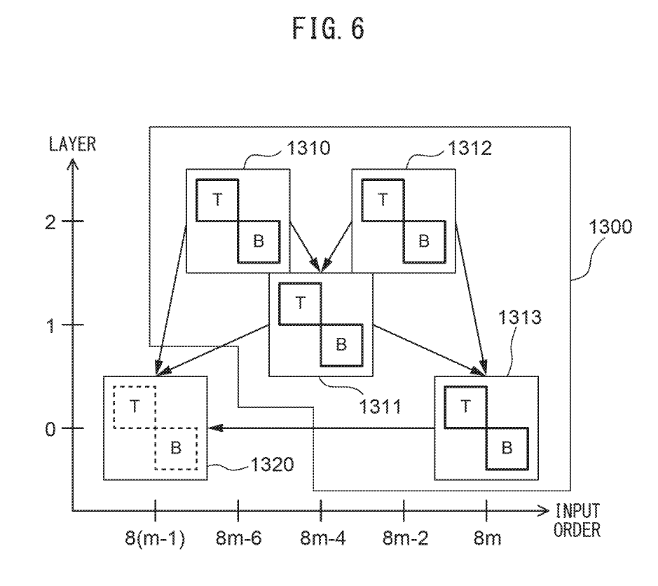

FIG. 6 is a diagram illustrating an example of a coding unit when the maximum layer number M is two, layer levels and a reference relationship of the pictures in the coding unit in the first embodiment. In the first embodiment, the control unit 11 always uses the same coding unit structure for all of the pictures irrespective of their motion vectors. In other words, in the first embodiment, a first coding unit structure and a second coding unit structure, which are described later, are the same as the coding unit structure illustrated in FIG. 6. In FIG. 6, the horizontal axis represents input order (display order), and the vertical axis represents layer.

A single coding unit 1300 includes four field pairs 1310 to 1313. A field pair 1320 is included in the coding unit that is immediately prior to the coding unit 1300 in the coding order. Each field pair includes a top filed and a bottom field. In the first embodiment, a top field and a bottom field of the same field pair have the same layer level, and are encoded consecutively in field coding.

When the two fields included in each of the field pairs 1310 to 1313 are encoded by field coding, (8m−6), (8m−5), (8m−4), (8m−3), (8m−2), (8m−1), (8m), and (8m+1) are assigned to the respective fields as the POC values of the corresponding field pictures (where m is an integer). In contrast, when the field pairs 1310 to 1313 are encoded by frame coding, (8m−6), (8m−4), (8m−2), and (8m) are assigned to the respective field pairs as the POC values of the frame pictures.

Arrows presented in FIG. 6 indicate the reference relationship between the field pairs 1310 to 1313 when all the field pairs 1310 to 1313 are to be encoded by frame coding. Pictures possible to be referred to by a coding target picture in inter-predictive coding are limited to those each having the same or lower layer level as that of the coding target picture. In contrast, when the field pairs 1310 to 1313 are to be encoded by field coding, a coding target field picture can refer to both fields of each field pair possible to be referred to in frame coding. For example, the picture (8m−2) can refer to both the picture (8m−4) and the picture (8m−5). Further, when a coding target field picture is a bottom field picture, the field picture can refer to the top field of the same field pair. For example, the picture (8m−1) included in the field pair 1312 can refer to the picture (8m−2) included in the same field pair 1312.

The field-pair based coding order is as follows: the field pairs 1313, 1311, 1310, and then 1312. The control unit 11 determines, for each field pair, the picture type (frame or field) to be used for encoding the field pairs, in the following method.

Before the coding, the control unit 11 performs motion vector search by assuming that one of the top filed and the bottom field of each field pair is a coding target picture while the other is a reference picture. The control unit 11 performs the motion vector search through block matching carried out for each block obtained by dividing each picture into blocks each having N-by-N pixels and not overlapping. When the average value of the absolute values of the motion vectors of all the blocks is smaller than a threshold value, the control unit 11 performs frame coding on the field pair. In contrast, when the average value is larger than or equal to the threshold value, the control unit 11 performs field coding on the field pair. Thus, when the motion degree of objects captured in a field pair is relatively small, the video encoding apparatus 10 performs frame coding on the field pair, consequently increasing coding efficiency. In contrast, when the motion degree of objects captured in a field pair is relatively large, the video encoding apparatus 10 performs field coding on the field pair, consequently increasing coding efficiency. The threshold value is set at a value corresponding to a few pixels of the frame, for example.

The method for searching a motion vector is not limited to the above-described method. For example, the control unit 11 may carry out motion vector search only for certain blocks in a field picture. Alternatively, the control unit 11 may use the field pairs immediately before or after the field pair on which frame/field coding determination is performed, as reference pictures. In this case, the control unit 11 carries out motion vector search by using one of the fields of the determination target field pair as a coding target picture and using one of the fields of the field pair immediately before or after the field pair as a reference picture.

The control unit 11 may use a PU in the HEVC standard for each block for which motion vector search is carried out. The control unit 11 may use only the luminance components of a coding target picture and a reference picture for motion vector search.

The control unit 11 may determine a coding unit structure by using the average value of the absolute values of the motion vectors of all or some of the field pairs in the coding unit. Specifically, the control unit 11 uses the first coding unit structure when the average value of the absolute values of the motion vectors is smaller than a threshold value, and uses the second coding unit structure when the average value of the absolute values of the motion vectors is larger than the threshold value. As described above, in the first embodiment, the first coding unit structure and the second coding unit structure are the same.

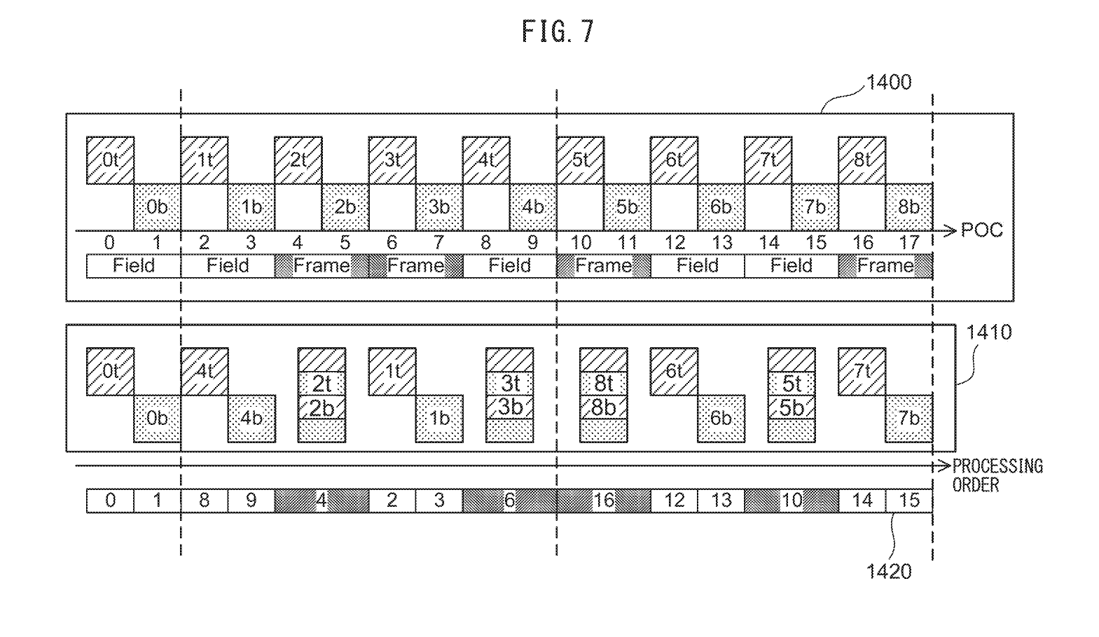

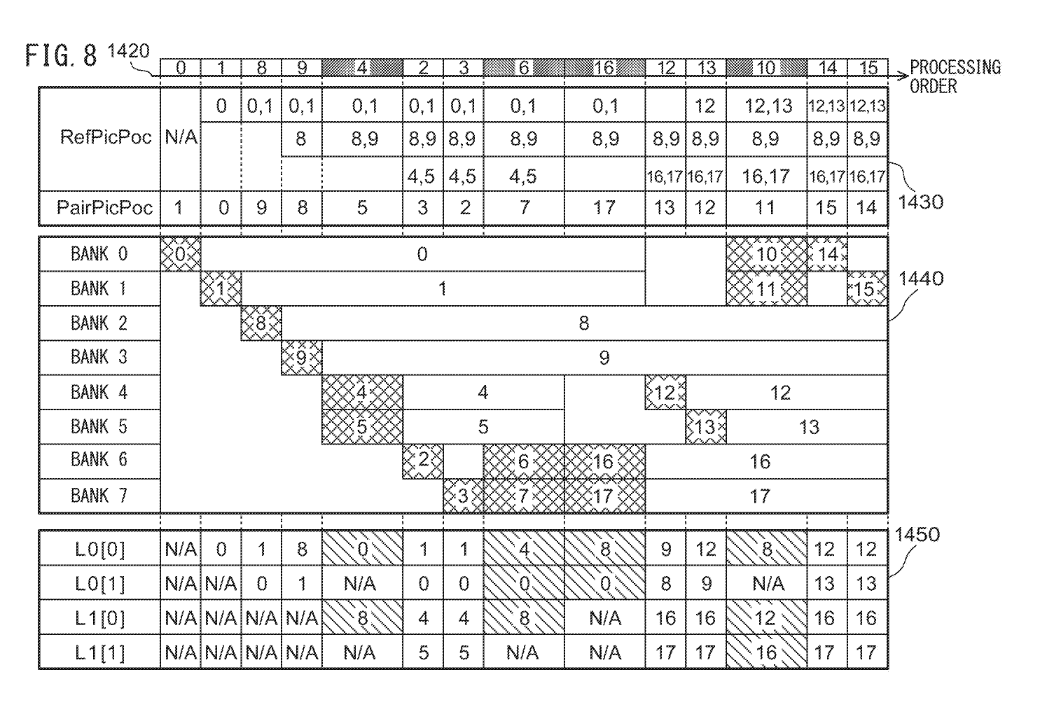

The video encoding apparatus 10 encodes each picture according to the coding structure (frame or field) of the coding unit and the field pairs determined by the above-described manner. Description is given of coding parameters of pictures and DPB management with reference to FIG. 7 and FIG. 8.

A video 1400 illustrated in FIG. 7 includes multiple field pictures. Among the field pictures, each block with “nt” is a top field picture included in the n-th field pair in the input order. Each block with “nb” is a bottom field picture included in the n-th field pair in the input order. The numbers 0, 1, 2, . . . , and 17 indicated below the respective field pictures are the POC values of the corresponding field pictures. For example, the POC value of the top field picture (1t) is two, and the POC value of the bottom field picture (2b) is five. Expressions ‘Field’ and ‘Frame’ provided below the POC values indicate picture types (field and frame) in the coding determined in the above-described method. For example, the field pair (2t, 2b) corresponding to ‘Frame’ is encoded as a frame picture. In contrast, the two field pictures (4t) and (4b) included in the field pair (4t, 4b) corresponding to ‘Field’ are encoded as field pictures.

A coding structure 1410 presents the picture types of the respective pictures in the coding, in the cording order. The control unit 11 includes only the first field pair (0t, 0b) to be encoded by intra-predictive coding, into a coding unit including only a single field pair, and includes the other field pairs into coding units when M is two as illustrated in FIG. 6. Specifically, the field pictures {1t, 1b, . . . , 4t, 4b} are included in the second coding unit, and the field pictures {5t, 5b, . . . , 8t, 8b} are included in the third coding unit. In each of the second and subsequent coding units, the first field pair is a P picture, and the other field pairs are B pictures. The pictures having a layer level of two (i.e., pictures having the highest layer level) are non-reference pictures. The vertical broken lines in FIG. 7 indicate boundaries between the coding units.

In the coding structure 1410, each square block with either ‘nt’ or ‘nb’ represents a single picture treated as a field picture in the coding. Each rectangular block with ‘nt nb’ represents, on the other hand, a single picture treated as a frame picture in the coding. A horizontally long block sequence 1420 provided below the coding structure 1410 and including numeric values indicates the picture structures of the respective pictures. Each white block indicates that the corresponding picture above the block is to be encoded by field coding. In contrast, each shaded block indicates that the corresponding picture above the block is to be encoded by frame coding. The numeric value of each block corresponds to the POC value of the corresponding picture above the numeric value. In the following description, pictures treated as a single picture in the coding is referred to simply as a coding picture.

With reference to FIG. 8, description is given of parameters of each picture and a DPB state based on the coding units and the picture structures illustrated in FIG. 7. For the video decoding apparatus 20, a local decoded picture in the following description is read as a decoded picture.

In this embodiment, the number of banks (for both reference pictures and local decoded pictures) in a DPB, i.e., a frame buffer is eight, and the upper limit of each of the numbers of L0-direction reference pictures and L1-direction reference pictures is two. The number of banks and the upper limits of the number of reference pictures are, for example, externally set, and are notified to the control unit 11 and the reference picture management unit 12. For the video decoding apparatus 20, the number of banks and the upper limits of the numbers of reference pictures are set by the parameter values in the bit stream of encoded data.

The block sequence 1420 corresponds to the block sequence 1420 illustrated in FIG. 7 and indicates the picture structures and the POC values of the pictures in the coding order. In FIG. 8, the horizontal axis represents coding (decoding) order.

A table 1430 presents parameters included in each coding picture. Parameters RefPicPoc and PairPicPoc respectively indicate RPS information and reference pair information of each coding picture. For example, the RPS information (RefPicPoc) of the frame picture to be encoded fifth (having a POC value of four) indicates that the field pictures having POC values of zero, one, eight, and nine are stored in the DPB. The reference pair information (PairPicPoc) of the frame picture is five, which is the POC value of the bottom field picture included in the field pair corresponding to the frame picture.

The POC value and the RPS information of each coding target picture is notified to the video decoding apparatus 20 in a similar method as that employed in the HEVC standard. The notification method will be described later.

The reference picture management unit 12 determines RPS information in the following manner. Each picture having a layer level of zero is stored in the DPB until two field pairs having a layer level of zero are encoded subsequently. This is because, since a picture having a layer level of zero can only refer to a picture having the same layer level, one picture having a layer level of zero may be referred to by the picture having a layer level of zero to be encoded second after the one picture. For example, the pictures having POC values of zero and one are deleted from the DPB after the picture having a POC value of 16 is encoded.

The picture having a layer level of one is stored in the DPB until immediately before a field pair having a layer level of zero is encoded subsequently. For example, the pictures having POC values of four and five are deleted from the DPB immediately before the picture having a POC value of 16 is encoded.

The reference pair information PairPicPoc indicates the POC value of the field picture that is to be paired with the field picture to which the parameter is added when the field picture is to be referred to as a frame picture and that has a different parity. In the first embodiment, the field picture that is to be paired and has the different parity corresponds to the other field picture of the same field pair. When a coding picture is a frame picture (formed by both of the field pictures of the same field pair), the control unit 11 sets the POC value of the coding picture at the POC value of the top field picture and the PairPicPoc value at the POC value of the bottom field picture.

For example, PairPicPoc of the picture having a POC value of eight is nine. When the frame picture having a POC value of four and to be encoded later than the picture having a POC value of eight refers to the (field) picture having a POC value of eight as an L1[0] reference picture, the frame picture refers to the combination of the field picture having a POC value of eight and a field picture having a POC value of nine as a single frame picture. When two field pictures are referred to as a frame picture, it is inevitable that the two field pictures are stored in the DPB as reference pictures.

A table 1440 presents the contents of the DPB controlled on the basis of RefPicPoc information. Each number included in the same row as a bank name indicates the POC value of a picture stored in the bank. For example, when a picture having a POC value of zero is to be encoded, local decoded pictures of the picture are stored in the bank 0. The banks in which local decoded pictures are stored are shaded. In the coding of the picture having a POC value of one next, the picture having a POC value of zero is used as a reference picture. The picture having a POC value of zero is stored in the bank 0 until the subsequent coding of the picture having a POC value of 12.

A table 1450 presents lists L0 and L1 of reference pictures generated on the basis of the pictures stored in the DPB. When a coding picture is a field picture, the entries of each of L0 and L1 are determined in a similar method as that for determining reference pictures defined in the HEVC standard. In contrast, when a coding picture is a frame picture, the entries of each of L0 and L1 are determined in a similar method as that for determining reference pictures defined in the HEVC standard, and thereafter the entries of the field picture to be paired when being referred to are deleted. For example, when a frame picture having a POC value of four is to be encoded, the field pictures having POC values of zero, one, eight, and nine have been stored in the DPB. In this case, the picture 1 forms a reference frame picture with the picture 0, and the picture 9 forms a reference frame picture with the picture 8. Accordingly, the picture 1 and the picture 9 are deleted from the lists L0 and L1. As a result of the deletion, the lists L0 include only the picture 0, and the lists L1 include only the picture 8.

As described above, each entry of each of the lists L0 and L1 indicates a single field picture irrespective of coding picture type (field or frame). Hence, the lists L0 and L1 and the parameters RefIdxL0 and RefIdxL1 according to this embodiment are compatible with those in the HEVC standard.

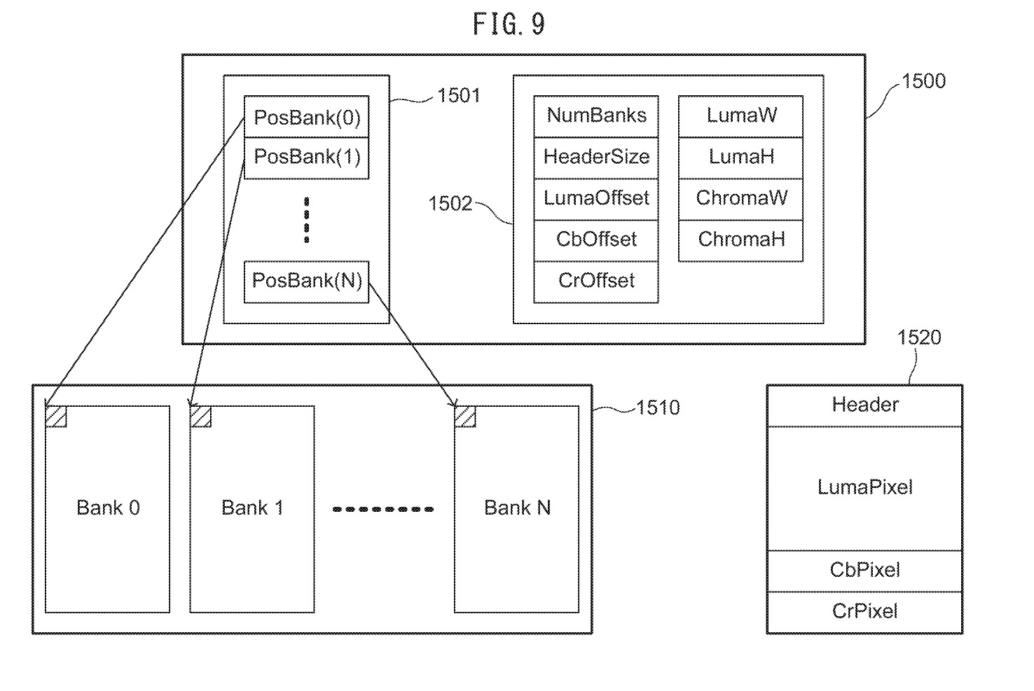

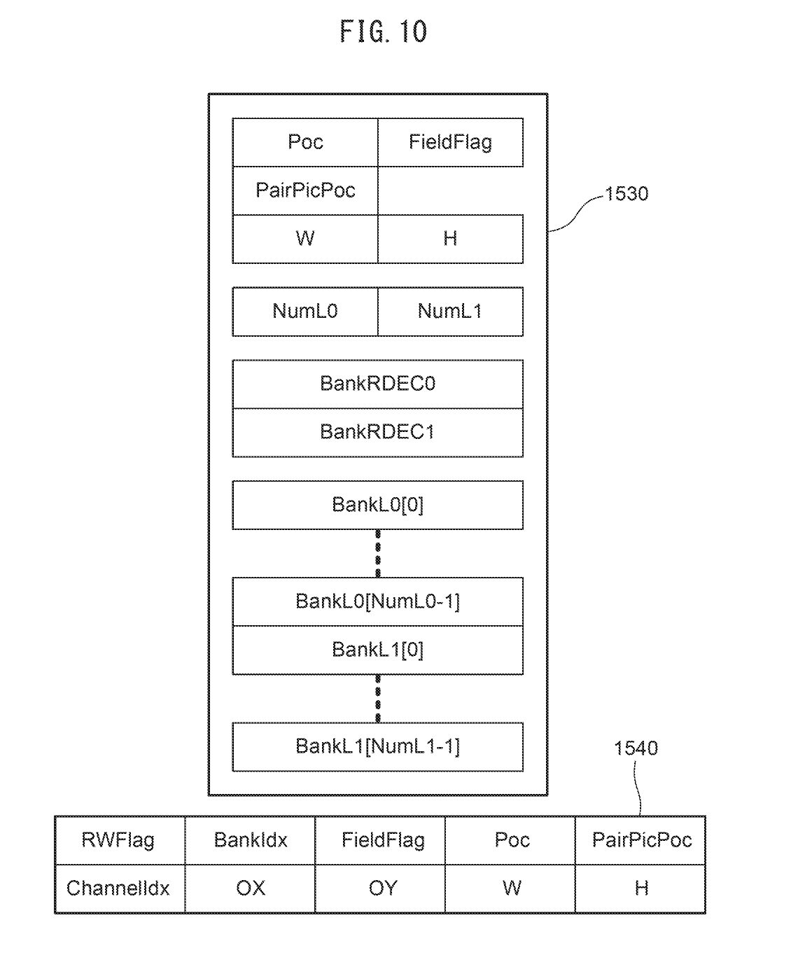

With reference to FIG. 9 and FIG. 10, description is given of operation for accessing banks via the buffer interface unit 14 in the video encoding apparatus 10 and communication data formats exchanged among the units of the video encoding apparatus 10. Note that operation and communication data formats in the video decoding apparatus 20 are approximately the same as those of the video encoding apparatus 10, and explanation of different respects is also included in the following description. For the video decoding apparatus 20, a coding target picture in the following description is read as a decoding target picture.

A memory 1500 is an embedded memory of the buffer interface unit 14 of the video encoding apparatus 10 (or the buffer interface unit 23 in the video decoding apparatus 20). A register group 1501 of the buffer interface unit 14 includes (N+1) registers PosBank(0), . . . , and PosBank(N) in each of which the starting address of a corresponding bank in the frame buffer 15 is stored. A register group 1502 stores parameters related to pictures. Each register of the register group 1502 stores information as follows: NumBanks stores the number of banks; HeaderOffset, the offset to the header region in each bank; LumaOffset, the offset to each picture luminance component; CbOffset, the offset to each picture Cb component; CrOffset, the offset to each picture Cr component; LumaW, the width of each picture luminance component; LumaH, the height of each picture luminance component; ChromaW, the width of each picture chrominance component; and ChromaH, the height of each picture chrominance component.

Before starting coding operation, the control unit 11 initializes the buffer interface unit 14. In the video decoding device 20, the entropy decoding unit 21 initializes the buffer interface unit 23 on the basis of the parameters in a bit stream. In the initialization, the control unit 11 notifies the buffer interface unit 14 of the number (N+1) of banks in the frame buffer, the width w of a picture plane (the number of pixels in the horizontal direction of a frame picture) w, and the height h of the picture plane (the number of pixels in the vertical direction of the frame picture). The buffer interface unit 14 (or the buffer interface unit 23 in the video decoding apparatus 20) sets the values of the registers in the register groups 1501 and 1502 on the basis of the notified information. When a coding picture has a 4:2:0 chrominance format, the following values are stored in the respective registers.

NumBanks=(N+1)

LumaW=w

LumaH=h

ChromaW=w/2

ChromaH=h/2

HeaderSize=C0 (fixed value)

LumaOffset=HeaderSize

CbOffset=HeaderSize+(w*h)

CrOffset=HeaderSize+(w*h)*3/2

PosBank(0)=C1 (fixed value)

PosBank(1)=PosBank(0)+B

PosBank(2)=PosBank(1)+B, . . .

PosBank(N)=PosBank(N−1)+B

In this case, B=(HeaderSize+(w*h)*2).

A memory map 1510 schematically illustrates the memory region of each of the banks in the frame buffer 15 of the video encoding apparatus 10 (or the frame buffer 24 in the video decoding apparatus 20). The address stored in each of registers PosBank(m) (m=0, 1, . . . , N) corresponds to the starting address of the bank m in the frame buffer 15.

A memory map 1520 presents the memory structure of each bank in the frame buffer 15 (or the frame buffer 24 in the video decoding apparatus 20). In each bank, a header area Header of C0 bytes, a luminance pixel value area LumaPixel, a Cb pixel value area CbPixel, and a Cr pixel area CrPixel are arranged in this order from a starting point on consecutive memory addresses.

Before starting the coding of each picture, the reference picture management unit 12 of the video encoding apparatus 10 notifies the source encoding unit 13 (or, in the video decoding apparatus 20, the reference picture management unit 22 notifies the source decoding unit 25) of coding picture information and reference picture bank information.

In FIG. 10, a data structure 1530 presents the data structure of coding picture information and reference picture bank information. Poc, FieldFlag, and PairPicPoc respectively indicate the POC value of a coding target picture, the flag indicating the structure of the coding target picture (‘1’ for field; ‘0’ for frame), and the POC value of the field picture to be paired in frame reference. W and H respectively indicate the number of horizontally aligned pixels and the number of vertically aligned pixels in the coding target picture. NumL0 and NumL1 respectively indicate the number of entries in the list L0 and the number of entries in the List L1. BankRDEC0 and BankRDEC1 indicate the bank numbers of the banks in each of which local decoded pictures are stored. Only BankRDEC0 is used when the coding target picture is a field picture, whereas the bank number of a bank storing a top field picture is stored in the BankRDEC0 and the bank number of a bank storing a bottom field picture is stored in BankRDEC1 when the coding target picture is a frame picture. BankL0[n] and BankL1[m] respectively indicate the bank number of the bank storing a reference picture L0[n] and the bank number of the bank storing a reference picture L1[m].

When writing the pixel values of a local decoded picture in the frame buffer 15 via the buffer interface unit 14, the source encoding unit 13 of the video encoding apparatus 10 transmits a write request having a data structure 1540 illustrated in FIG. 10 to the buffer interface unit 14. When reading pixel values from the frame buffer 15, the source encoding unit 13 transmits a read request having the data structure 1540 to the buffer interface unit 14. Similarly, in the video decoding apparatus 20, when writing pixel values of a decoded picture in the frame buffer 24 via the buffer interface unit 23, the source decoding unit 25 transmits a write request having the data structure 1540 to the buffer interface unit 23. When reading the pixel values of a decoded picture from the frame buffer 24, the source decoding unit 25 transmits a read request having the data structure 1540 to the buffer interface unit 23. When reading the pixel values of a reference picture, a read request having the data structure 1540 is used.

The data structure 1540 includes the following data: RWFlag indicating the flag indicating read or write (‘1’ for write; ‘0’ for read); BankIdx, a target bank number; and FieldFlag, the structure of a coding target picture (‘1’ for field; ‘0’ for frame). In addition, the data Poc indicates the POC value of the coding target picture; the data PairPicPoc, the PairPicPoc value of the coding target picture; and the data ChannelIdx, the flag indicating the classification of the pixel values (‘0’ for luminance; ‘1’ for Cb; and ‘2’ for Cr). The data OX, OY, W, and H indicate the X coordinate and the Y coordinate of the upper left position of the rectangular area serving as a pixel unit for read and write, and the width and the height of the rectangular area serving as a pixel unit for read and write in the picture, respectively. Poc and PairPicPoc are used only when RWFlag=1. The above data are stored in Header in the memory map 1520 of a corresponding bank.

The buffer interface unit 14 (or the buffer interface unit 23 in the video decoding apparatus 20) calculates the address of the pixel at the left end in the p-th line (p=[0, H−1]) counted from the upper end of the picture in an area to be written to or an area to be read from a bank b (b=[0, N]) from the frame buffer 15 (or the frame buffer 24 in the video decoding apparatus 20), as follows.

FieldFlag=1 (field): OffsetA+((OY+p)*pw)

FieldFlag=0 (frame): OffsetB+(((OY+p)/2)*pw)

where OffsetA corresponds to the address of the upper left end pixel of a field picture and is (PosBank(b)+HeaderSize+LumaOffset) when ChannelIdx is 0 (luminance), (PosBank(b)+HeaderSize+CbOffset) when ChannelIdx is 1 (Cb), and (PosBank(b)+HeaderSize+CrOffset) when ChannelIdx is 2(Cr). In addition, pw is LumaW when ChannelIdx is 0, ChromaW when ChannelIdx is 1, and ChromaW when ChannelIdx is 2.

Offset B corresponds to the address of the upper left end pixel of each of the two field pictures included in the frame picture and is (X+HeaderSize+LumaOffset) when ChannelIdx is 0, (X+HeaderSize+CbOffset) when ChannelIdx is 1, and (X+HeaderSize+CrOffset) when ChannelIdx is 2. Note that X is PosBank(b) when (OY+p) %2 is zero, i.e., for the top field picture, and is PosBank(b′) when (OY+p) %2 is one, i.e., for the bottom field picture. Here, b′ indicates the bank number having the same POC value as PairPicPoc when RWFlag is one and the bank number having the same POC value as PairPicPoc included in the Header information of the bank b when RWFlag is zero. Specifically, when FieldFlag is one, the source encoding unit 13 assumes that the frame buffer 15 (or, in the video decoding apparatus 20, the source decoding unit 25 assumes that the frame buffer 24) manages the DPB on a frame-picture-by-frame-picture basis, and reads/writes data on the frame picture. The buffer interface unit 14 (or the buffer interface unit 23 in the video decoding apparatus 20) reads/writes data from/to the bank storing the corresponding field picture on a line-by-line basis, in order to deal with the difference in picture structure.

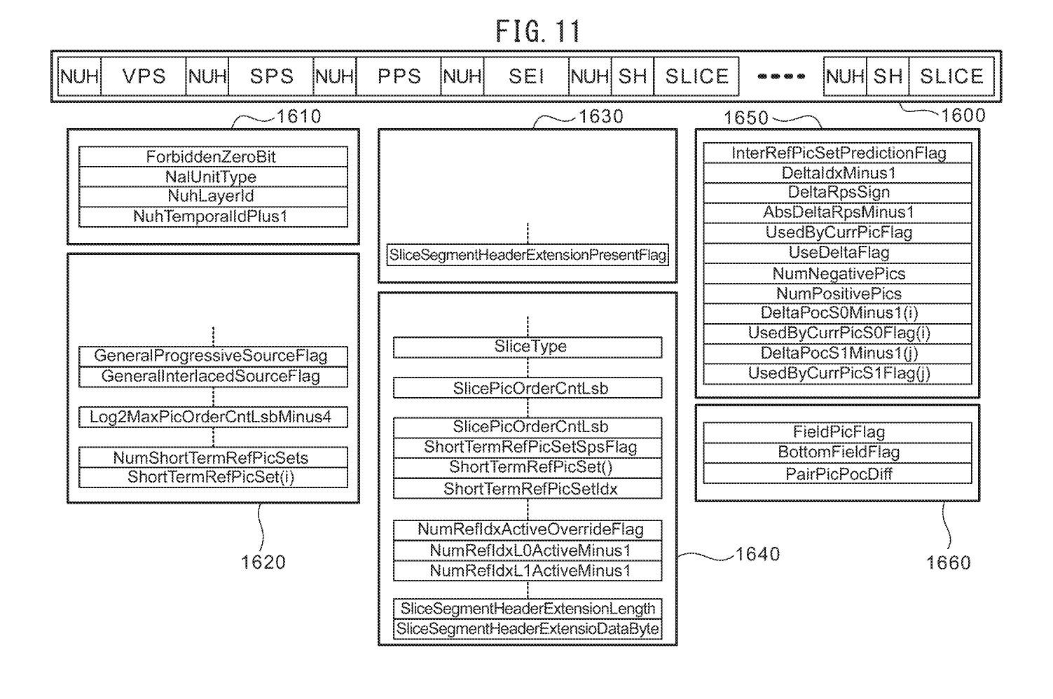

A structure of a bit stream including coding video data according to the first embodiment will be described with reference to FIG. 11.

Data 1600 illustrates to data on a single coding picture in a bit stream. The syntax elements, i.e., NAL unit header (NUH), video parameter set (VPS), sequence parameter set (SPS), picture parameter set (PPS), supplemental enhancement information (SEI), slice segment header (SH), and slice segment data (SLICE) are the same as the syntax elements having the same names defined in the HEVC standard, except for SH. SH is partially extended compared with the syntax element having the same name defined in the HEVC standard. The syntax elements are described later in detail.

A parameter set 1610 includes the parameters included in NUH. A parameter NalUnitType indicates the type of raw byte sequence payload (RNSP) following the NUH. For example, when the RBSP following the NUH is VPS, the parameter NalUnitType is ‘VPS NUT’(32). A parameter NuhTemporalIdPlus1 indicates the number of layers.

A parameter set 1620 includes the parameters included in SPS. Herein, only the parameters related to this embodiment are particularly illustrated. The parameters in each RBSP appear in a bit stream sequentially from the parameter presented at the top. Each dotted vertical line in FIG. 11 indicates that one or more parameters that are not particularly described in this specification exist between the explicitly listed parameters. Parameters GeneralProgressiveSourceFlag and GeneralInterlaceSourceFlag are respectively 0 and 1 in this embodiment, and indicate respectively that the coding target video is a progressive video and that the coding target video is an interlaced video. A parameter Log2MaxPicOrderCntLsbMinus4 is used for restoring the POC value indicated in SH. A parameter NumShortTermRefPicSets indicates the number of RPSs described in the SPS. A parameter ShortTermRefPicSet(i) describes the i-th RPS (i=[0, NumShortTermRefPicSets−1]). The parameter ShortTermRefPicSet(i) will be described later in detail.

A parameter set 1630 includes the parameters included in the PPS. Herein, only the parameter related to this embodiment is particularly presented. A parameter SliceSegmentHeaderExtensionPresentFlag is set at one in order to describe a parameter SliceSegmentHeaderExtensionLength in the SH.

A parameter set 1640 includes the parameters included in the SH. Herein, only the parameters related to this embodiment are particularly illustrated. A parameter SliceType indicates a slice type (0, B slice; 1, P slice; and 2, I slice). A parameter SlicePicOrderCntLsb indicates the LSB of the POC value of the coding picture including the SLICE following the SH. The POC value of the picture corresponding to the data 1600 will be described in the same describing manner as that for a POC value in the HEVC standard by use of the parameters SlicePicOrderCntLsb and Log2MaxPicOrderCntLsbMinus4. A parameter ShortTermRefPicSetSpsFlag describes whether to use the RPS described in the SPS as the RPS of the SLICE of the data 1600 (1) or not (0). In this embodiment, the parameter ShortTermRefPicSetSpsFlag is set at one to make explanation simple. A parameter ShortTermRefPicSet( ) describes the RPS of the SLICE of the data 1600. The parameter ShortTermRefPicSet( ) will be described later in detail. A parameter ShortTermRefPicSetIdx indicates the RPS to be used among the multiple RPSs described in the SPS, when the parameter ShortTermRefPicSetSpsFlag is zero. A parameter NumRefIdxActiveOverrideFlag describes whether parameters NumRefIdxL0ActiveMinus1 and NumRefIdxL1ActiveMinus1 indicating the respective numbers of entries in the lists L0 and L1 appear in the SH (1) or not (0). A parameter SliceSegmentHeaderExtensionLength describes the data size (in byte) needed for writing the parameter set 1660. A parameter SliceSegmentHeaderExtensionDataByte includes the parameter set 1660.

A parameter set 1650 includes the parameters included in ShortTermRefPicSet( ) in the parameter set 1620. When the SPS includes multiple RPSs, a parameter InterRefPicSetPredictionFlag describes whether to predict, on the basis of an RPS, another RPS or not (1, to predict; 0, not to predict). To make explanation simple, the parameter InterRefPicSetPredictionFlag is set at zero in this example. Parameters DeltaIdxMinus1, DeltaRpsSign, AvsDeltaRpsMinus1, UsedByCurrPicFlag, and UseDeltaFlag are described only when the parameter InterRefPicSetPredictionFlag included in the parameter set 1650 is one. A parameter numNegativePics describes the number of reference pictures each having a POC value smaller than the POC value of the picture including the SH of the data 1600, and a parameter numPositivePics describes the number of reference pictures each having a POC value larger than the POC value of the picture including the SH of the data 1600. A parameter DeltaPocS0Minus1(i) (i=[0, numNegativePics−1]) and a parameter DeltaPocS1Minus1(j) (j=[0, numPositivePics−1]) are used to obtain the POC value of each reference picture. The parameter DeltaPocS0Minus1(i) and the parameter DeltaPocS1Minus1(j) will be described later in detail. A parameter UsedByCurrPicS0Flag(i) (i=[0, numNegativePics−1]) and a parameter UsedByCurrPicS1Flag(j) (j=[0, numPositivePics−1]) describe respectively whether the i-th reference picture is to be referred to by the picture including the SH (1) or not (0) and whether the j-th reference picture is to be referred to by the picture including the SH (1) or not (0).

The parameter set 1660 includes the parameters included in SliceSegmentHeaderExtensionDataByte. A parameter FieldPicFlag is set at one when the picture corresponding to the data 1600 is a field picture, and is set at zero when the picture corresponding to the data 1600 is a frame picture. A parameter BottomFieldFlag is set at one when the picture corresponding to the data 1600 is a bottom field picture, and is set at zero when the picture corresponding to the data 1600 is a top field picture. When FieldPicFlag is zero, the parameter BottomFieldFlag is not defined.

A parameter PairPicPocDiff is an example of reference pair information and describes the value obtained by subtracting the POC value of the picture corresponding to the data 1600 from the POC value of the other field picture to be paired when it is referred to by a frame picture.

A method of determining the value of each of the parameters numNegativePics, numPositivePics, DeltaPocS0Minus1( ) and DeltaPocS1Minus1( ) will be described with reference to FIG. 8.

As presented in the table 1430, the pictures having POC values of zero, one, four, five, eight, and nine are stored in the DPB for the picture (frame) having a POC value of six. To describe the RPS corresponding to each of the pictures stored in the DPB, the parameters numNegativePics, numPositivePics, DeltaPocS0Minus1( ) and DeltaPocS1Minus1( ) are set as follows.

First, the DPB stores four pictures each having a POC value (zero, one, four, or five) smaller than six, which is the POC value of the target picture, and two pictures each having a POC value (eight or nine) larger than six, which is the POC value of the target picture. Accordingly, the parameters numNegativePics and numPositivePics are set as follows.

numNegativePics=4

numPositivePics=2

DeltaPocS0Minus1(i) describes the POC value of the pictures stored in the DPB and each having a smaller POC value than the POC value of the coding target (decoding target) picture, by use of the values each obtained by subtracting one from the difference between the POC value of the picture and the POC value of the picture immediately before the picture, sequentially from the picture having a POC value closest to the POC value of the target picture. Accordingly, in this example, DeltaPocS0Minus1(i) is determined as follows.

DeltaPocS0Minus1(0)=0: corresponding to POC=5=6−(5+1))

DeltaPocS0Minus1(1)=0: corresponding to POC=4=5−(4+1))

DeltaPocS0Minus1(2)=2: corresponding to POC=1=4−(1+1))

DeltaPocS0Minus1(3)=0: corresponding to POC=0=1−(0+1))

DeltaPocS1Minus1(i) describes the POC values of the pictures stored in the DPB and each having a larger POC value than the POC value of the coding target (decoding target) picture, the pictures by use of the values each obtained by subtracting one from the value obtained by subtracting the POC value of the picture immediately before the picture from the POC value of the target picture, sequentially from the picture having a POC value closest to the POC value of the target picture. Accordingly, in this example, DeltaPocS1Minus1(i) is determined as follows.

DeltaPocS1Minus1(0)=1: corresponding to POC=8=8−(6+1))

DeltaPocS1Minus1(1)=0: corresponding to POC=9=9−(8+1))

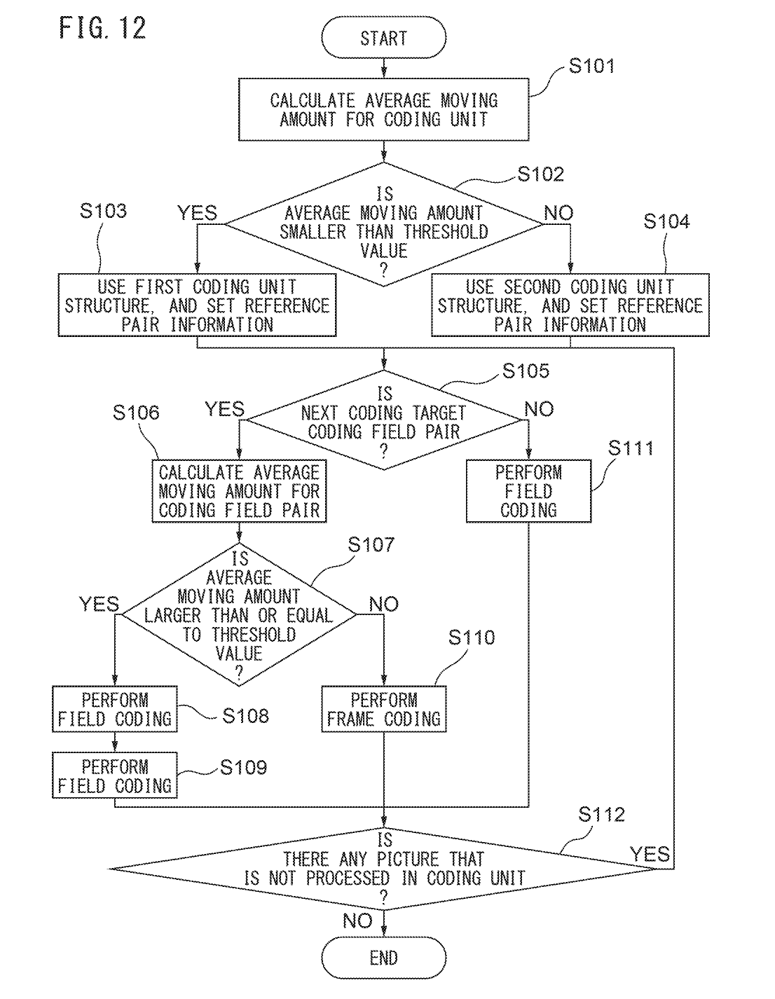

FIG. 12 is an operational flowchart of a video encoding process according to the first embodiment. The video encoding apparatus 10 carries out the encoding process for each coding unit in accordance with the operational flowchart.

Before the coding of each picture in the coding unit, the control unit 11 calculates the average moving amount for the coding unit (Step S101). For example, the control unit 11 calculates the average value of the absolute values of the block-based motion vectors between corresponding to the two fields included in each field pair in the coding unit. The control unit 11 also calculates the average moving amount for the coding unit by averaging the average values of the absolute values of the motion vectors of the respective field pairs.

The control unit 11 determines whether or not the average moving amount of the coding unit is smaller than a predetermined threshold value Th (Step S102). The threshold value Th is set, for example, at a value corresponding to approximately several pixels of a frame. When the average moving amount is smaller than the threshold value Th (Yes in Step S102), the control unit 11 uses the first coding unit structure for the coding unit (Step S103). In the first embodiment, the first coding unit structure is that illustrated in FIG. 6, in which the field-pair-based coding order of the fields is specified. The control unit 11 sets reference pair information for each field on the basis of the coding unit structure and the like.

In contrast, when the average moving amount is larger than or equal to the threshold value Th (No in Step S102), the control unit 11 uses the second coding unit structure for the coding unit (Step S104). The control unit 11 then sets reference pair information for each field on the basis of the coding unit structure and the like. In the first embodiment, the second coding unit structure is also that illustrated in FIG. 6, in which the field-pair-based coding order of the fields is specified. However, the second coding unit structure may be one in which the field-based coding order of the fields is specified, as will be described later.

After Step S103 or S104, the control unit 11 determines whether or not the picture to be encoded next is a coding field pair (Step S105). In the first embodiment, it is assumed that a coding field pair (i.e., a pair of a top field and a bottom field to be encoded as a frame picture) is always a field pair. Accordingly, a picture to be encoded is always a field pair (Yes in Step S105). The control unit 11 then calculates the average moving amount for the coding field pair (Step S106). The average moving amount of the coding field pair may be, for example, the average value of the absolute values of the block-based motion vectors between the two fields included in the field pair.

The control unit 11 determines whether or not the average moving amount of the coding field pair is larger than or equal to a predetermined threshold value Th2 (Step S107). The threshold value Th2 may be the same as or different from the threshold value Th. The threshold value Th2 is set, for example, at a value corresponding to approximately several pixels of a frame.

When the average moving amount of the coding field pair is larger than or equal to the threshold value Th2 (Yes in Step S107), the control unit 11 determines to encode the field pair on a field-by-field basis. Then, the control unit 11 notifies the source encoding unit 13 that the field pair is to be encoded on a field-by-field basis.

The source encoding unit 13 performs inter-predictive or intra-predictive coding on the top field of the coding field pair according to the coding mode (Step S108). Then, the source encoding unit 13 outputs the data on the encoded top field to the entropy encoding unit 16, and the entropy encoding unit 16 performs entropy coding on the data. The source encoding unit 13 performs inter-predictive or intra-predictive coding on the bottom field of the coding field pair according to the coding mode (Step S109). The source encoding unit 13 then outputs the data on the encoded bottom field to the entropy encoding unit 16, and the entropy encoding unit 16 performs entropy coding on the data. The source encoding unit 13 writes a local decoded picture in the frame buffer 15 via the buffer interface unit 14. The reference picture management unit 12 updates the information on the encoded fields stored in the frame buffer 15.

In contrast, when the average moving amount of the coding field pair is smaller than the threshold value Th2 in Step S107 (No in Step S107), the control unit 11 determines to encode the field pair on a frame-by-frame basis. The control unit 11 notifies the source encoding unit 13 that the picture is to be encoded on a frame-by-frame basis. The source encoding unit 13 performs inter-predictive or intra-predictive coding on the coding field pair on a frame-by-frame basis according to the coding mode (Step S110). The source encoding unit 13 then outputs the data on the encoded field pair to the entropy encoding unit 16, and the entropy encoding unit 16 performs entropy coding on the data. The source encoding unit 13 writes a local decoded picture in the frame buffer 15 via the buffer interface unit 14. The reference picture management unit 12 updates the information on the encoded fields stored in the frame buffer 15.

When the picture to be encoded next is a field picture in Step S105 (No in Step S105), the control unit 11 determines to encoded the picture on a field-by-field basis. Then the control unit 11 notifies the source encoding unit 13 that the picture is to be encoded on a field-by-field basis.

The source encoding unit 13 performs inter-predictive or intra-predictive coding on the picture to be encoded next on a field-by-field basis according to the coding mode (Step S111).

After Step S109, S110, or S111, the control unit 11 determines whether or not there is any picture that is not encoded in the coding unit (Step S112). When there is a picture that is not encoded (Yes in Step S112), the control unit 11 repeats the process from Step S105. In contrast, when all of the pictures in the coding unit are encoded (No in Step S112), the control unit 11 terminates the video encoding process.

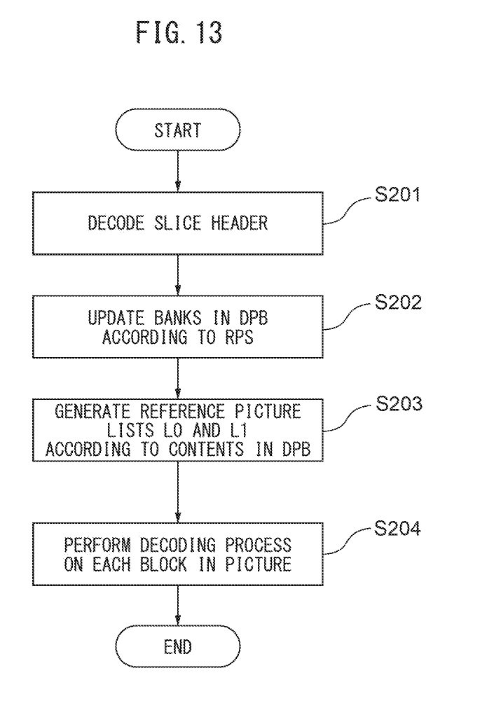

FIG. 13 is an operational flowchart of a video decoding process according to the first embodiment. The video decoding apparatus 20 carries out the decoding process for each picture in accordance with the operational flowchart.

The entropy decoding unit 21 decodes the data on and a slice header (SH) of a decoding target picture encoded by entropy coding (Step S201). The entropy decoding unit 21 notifies the reference picture management unit 22 of information needed for DPB management, such as the RPS information included in the SH and the reference pair information. The reference picture management unit 22 updates information on each bank in the DPB (i.e., the frame buffer 24) on the basis of the RPS information in the SH (Step S202). The reference picture management unit 22 also generates reference picture lists L0 and L1 for the decoding target picture on the basis of the contents in the DPB (Step S203). In the generation, when the decoding target picture is a frame picture, the reference picture management unit 22 determines two field pictures to be used for generating a frame picture corresponding to a reference picture to be included in the lists L0 and L1, with reference to the reference pair information. The reference picture management unit 22 then notifies the source decoding unit 25 of the reference picture lists L0 and L1.

The source decoding unit 25 identifies a reference picture on the basis of the received reference picture lists and coding parameters received from the entropy decoding unit 21, and decodes each block of the decoding target picture by use of the reference picture (Step S204). The source decoding unit 25 writes the decoded picture in the frame buffer 24 via the buffer interface unit 23. The reference picture management unit 22 updates the information on the frame buffer 24. The video decoding apparatus 20 thereafter terminates the video decoding process.

As described above, the video encoding apparatus and the video decoding apparatus according to this embodiment always use field pictures as pictures to be stored in the DPB irrespective of the type (field or frame) of a coding (decoding) target picture. In addition, the RPS information on a coding target picture is also always on a field-picture-by-field-picture basis. This allows the video encoding apparatus and the video decoding apparatus to always perform the same operation for the process of the RPS-based DPB management irrespective of the type of a coding (decoding) target picture. As a picture parameter to be added to coding data, reference pair information indicating the two field pictures to be paired when being referred to by a frame picture is defined. This allows the video encoding apparatus and the video decoding apparatus to encode or decode each picture by switching frame and field for each picture.

Next, a video encoding apparatus and a video decoding apparatus according to a second embodiment are described. The video encoding apparatus and the video decoding apparatus according to the second embodiment are different from the video encoding apparatus and the video decoding apparatus according to the first embodiment in that a coding unit structure in which the field-based coding order is specified (second coding unit structure) is also usable. Description is given below of the respects in which the first embodiment and the second embodiment are different.

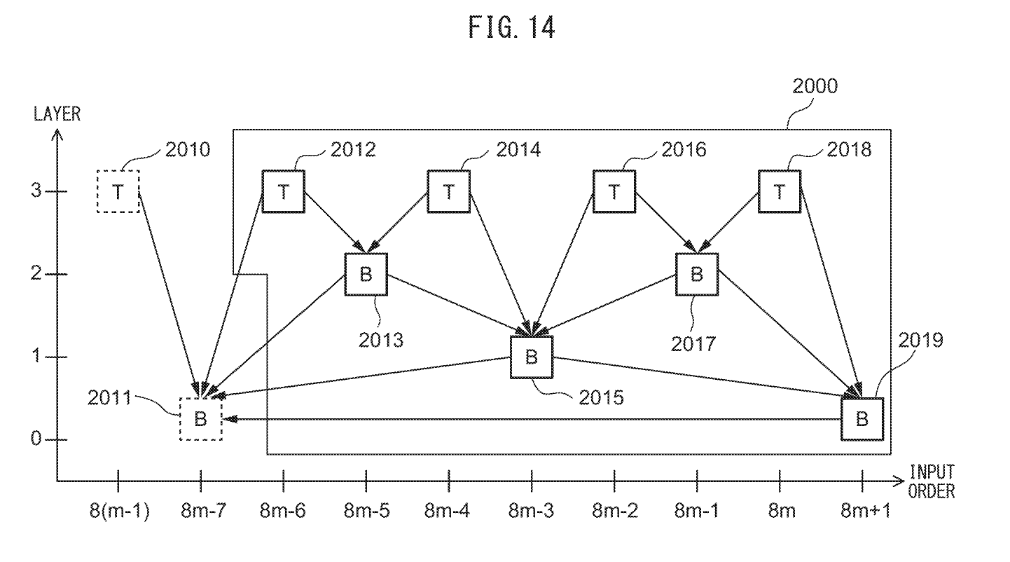

FIG. 14 is a diagram illustrating an example of a second coding unit when the maximum layer number M is two, layer levels and a reference relationship of the pictures in the coding unit.

A coding unit 2000 having the second coding unit structure includes only field pictures without including any field pair. Specifically, when a coding unit has the second coding unit structure, all of the pictures in the coding unit are encoded as field pictures. In this example, the coding unit 2000 includes eight field pictures 2012 to 2019. Field pictures 2010 and 2011 are included in a coding unit before the coding unit 2000.

The arrows in FIG. 14 indicate the reference relationship between the field pictures. Note that FIG. 14 illustrates only part of the reference relationship for simplicity.

In this example, the coding order of the field pictures 2012 to 2019 is as follows: the fields 2019, 2015, 2013, 2012, 2014, 2017, 2016, and then 2018.

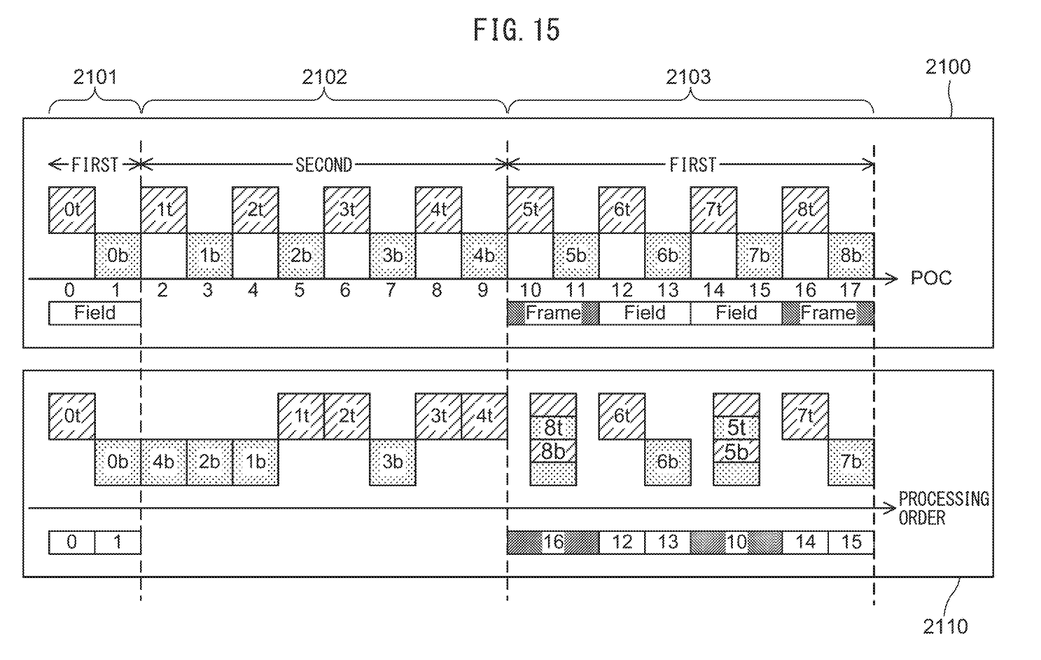

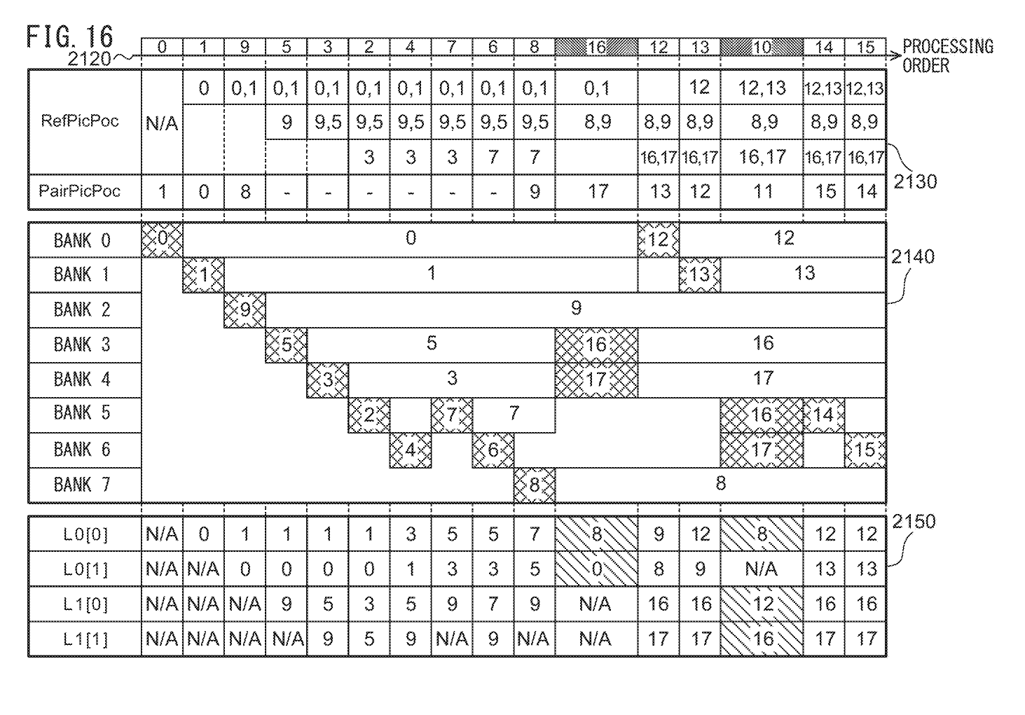

With reference to FIG. 15, description is given of the parameters of the pictures and a DPB state for a video data including both coding units having the first coding unit structure and a coding unit having the second coding unit structure.

As in the description of FIG. 7 and FIG. 8, a local decoded picture is read as a decoded picture for the video decoding apparatus 20.

A video 2100 includes three coding units 2101 to 2103 as in the video 1400 illustrated in FIG. 7. Each block represents a single field picture included in the video 2100. Among the blocks, each block with ‘nt’ represents a top field picture included in the n-th field pair in the input order, and each block with ‘nb’ represents a bottom field picture included in the n-th field pair in the input order.

On the basis of the motion vectors of the pictures, the first and third coding units 2101 and 2103 have the first coding unit structure (the structure illustrated in FIG. 6) and the second coding unit 2102 has the second coding unit structure (the structure illustrated in FIG. 14). When a coding unit has the second coding unit structure, the field pictures included in the coding unit are always encoded individually on a field-by-field basis.

A coding structure 2110 presents the picture types of the respective pictures in the coding, in the coding order. Different from the example illustrated in FIG. 8, each picture of any layer level can refer to a picture of a different layer level. The top field at the end in the display order in each coding unit can be referred to by a different picture.

With reference to FIG. 16, the parameters of the pictures and the DPB state on the basis of the coding units and the picture structures illustrated in FIG. 15 are described. For the video decoding apparatus 20, a local decoded picture is read as a decoded picture. In FIG. 16, the horizontal axis represents coding (decoding) order.

In this embodiment, as in the example in FIG. 8, the number of banks (including those for both reference pictures and local decoded pictures) in the DPB is eight, and the upper limit of the number of reference pictures in each of the L0 direction and the L1 direction is two. The number of banks and the upper limits of the numbers of reference pictures are, for example, externally set and notified to the control unit 11. In the video decoding apparatus 20, the number of banks and the upper limits of the numbers of the reference pictures are set by use of parameter values in a bit stream.

A block sequence 2120 presents the picture structures and the POC values of the pictures illustrated in FIG. 15 in the coding order. The numeric value in each block is the POC value of the corresponding picture illustrated in FIG. 15. Each white block indicates that the picture having the POC value included in the block is to be encoded by field coding. In contrast, each shaded block indicates that the picture having the POC value in the block is to be encoded by frame coding.

A table 2130 presents the parameters included in each coding picture. Different from the first embodiment, the parameter PairPicPoc of each field picture other than those having a POC value of eight or nine is not defined. A parameter PairPicPocDiff included in the bit stream structure in FIG. 11 is set at zero.

A table 2140 presents the contents of the DPB controlled on the basis of RefPicPoc information. Each number presented in the same row as a bank name indicates the POC value of the picture stored in the bank. For example, at the time of encoding the picture having a POC value of zero, local decoded pictures of the picture are stored in a bank 0. Each bank which stores local decoded pictures are illustrated with shade. When the picture having a POC value of one is encoded next, the picture having a POC value of zero is used as a reference picture. The picture having a POC value of zero is stored in the bank 0 until the picture having a POC value of 16 is encoded subsequently.

A table 2150 presents lists L0 and L1 of reference pictures generated on the basis of the pictures stored in the DPB. In this example, only the field pair including the field pictures 8 and 9 included in the second coding unit is referred to by the frame picture 16 as a reference frame. Each of all the other field pictures is referred to as a field by a coding target picture.

The parameter PairPicPoc of each field picture may have the same value as the POC value of the field picture including the parameter. The parameter PairPicPocDiff is set at zero also in this case. When a frame picture refers to the field picture, a reference frame picture is generated by interleaving the field picture as a top field and a bottom field.

According to a modified example, reference pair information may specify a combination of a top field picture and a bottom field picture that are apart from each other in terms of time. This allows the video encoding apparatus to generate a frame picture to be referred to in a more flexible manner in the frame-based coding of a picture, consequently increasing coding efficiency.

In this case, each parameter PairPicPoc does not need to include the POC value of the other field picture to be paired as a field pair. In the example in FIG. 16, when the field picture having a POC value of six is a reference picture, the parameter PairPicPoc of the field picture having a POC value of nine may be set at six, and the parameter PairPicPoc of the field picture having a POC value of six may be set at nine. In this case, the L0[0] of the frame picture having a POC value of 16 is six, and the frame picture generated by interleaving the picture having a POC value of six and the picture having a POC value of nine is referred to by the frame picture having a POC value of 16.

According to another modified example, the video encoding apparatus may use different POC values specified in each parameter PairPicPoc, which is reference pair information, for a top field and a bottom field. For example, the POC value specified for each field in each parameter PairPicPoc may be the POC value of the field immediately before this field in the display order. With this configuration, the video encoding apparatus can create different reference frames in the case of determining a field pair to be a reference frame by using the top field as a reference and the case of determining a field pair to be a reference frame by using the bottom field as a reference. This allows the video encoding apparatus to select a more optimal frame picture as a frame picture to be referred to in the frame-based coding of a picture, consequently increasing coding efficiency.

The video encoding apparatus and the video decoding apparatus according to any one of the above-described embodiments and the modified examples of the embodiments are used for various purposes. For example, the video encoding device and the video decoding apparatus may be incorporated in a video camera, a video transmitting apparatus, a video receiving apparatus, a video telephone system, a computer, or a mobile phone.

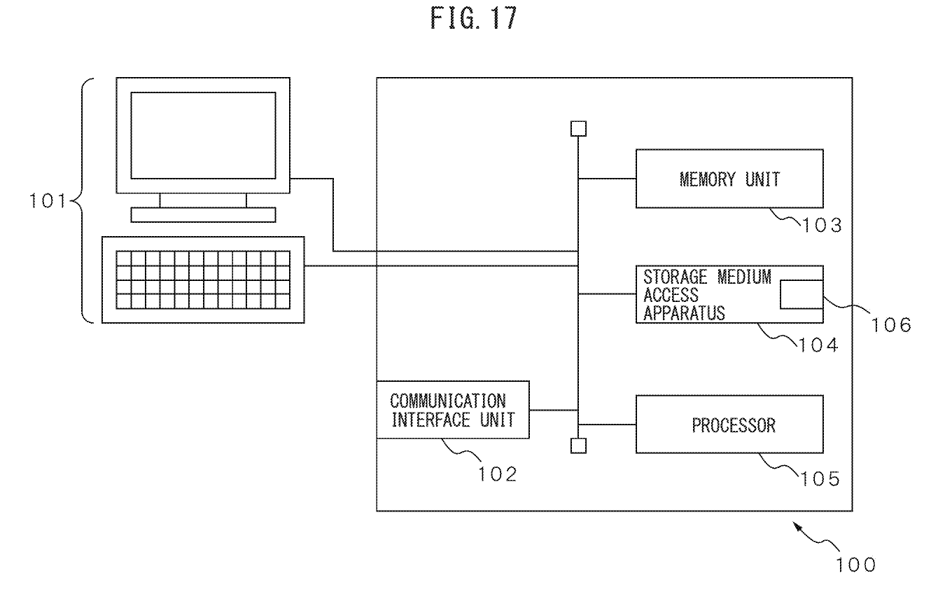

FIG. 17 is a diagram illustrating a configuration of a computer capable of operating as the video encoding apparatus or the video decoding apparatus by executing a computer program for implementing the functions of the units of the video encoding apparatus or the video decoding apparatus according to any one of the above-described embodiments and the modified examples of the embodiments.

A computer 100 includes a user interface unit 101, a communication interface unit 102, a memory unit 103, a storage medium access apparatus 104, and a processor 105. The processor 105 is connected to the user interface unit 101, the communication interface unit 102, the memory unit 103, and the storage medium access apparatus 104 via a bus, for example.

The user interface unit 101 includes, for example, input devices such as a keyboard and a mouse, and a display device such as a liquid crystal display. Alternatively, the user interface unit 101 may include a device in which an input device and a display device are integrated, such as a touch panel display. The user interface unit 101, for example, outputs an operation signal for selecting video data to be encoded or encoded video data to be decoded, to the processor 105 according to a user operation. In addition, the user interface unit 101 may display decoded video data received from the processor 105.

The communication interface unit 102 may include a communication interface for connecting the computer 100 to a device configured to generate video data, such as a video camera, and a control circuit for the communication interface. An example of the communication interface may be a universal serial bus (USB).

The communication interface unit 102 may include a communication interface for connecting the computer 100 to a communication network in accordance with a communication standard, such as Ethernet (registered trademark) and a control circuit for the communication interface.

In this case, the communication interface unit 102 acquires video data to be encoded or encoded video data to be decoded, from a different device connected to the communication network, and passes the data to the processor 105. The communication interface unit 102 may output encoded video data or decoded video data received from the processor 105, to a different device via the communication network.

The memory unit 103 includes a random access semiconductor memory and a read only semiconductor memory, for example. The memory unit 103 stores a computer program for performing the video encoding process or the video decoding process to be executed on the processor 105, and data generated during or as a result of the process. The memory unit 103 may function as the frame buffer according to any one of the above-described embodiments and the modified examples of the embodiments.

The storage medium access apparatus 104 accesses the storage medium 106, which is, for example, a magnetic disk, a semiconductor memory card, or an optical storage medium. The storage medium access apparatus 104 reads, for example, a computer program for the video encoding process or the video decoding process to be executed on the processor 105, stored in the storage medium 106, and passes the computer program to the processor 105

The processor 105 generates encoded video data by executing a computer program for the video encoding process according to any one of the above-described embodiments and the modified examples of the embodiments. The processor 105 stores the generated encoded video data in the memory unit 103 or outputs the generated encoded video data to a different device via the communication interface unit 102. The processor 105 decodes encoded video data by executing a computer program for the video decoding process according to any one of the above-described embodiments and the modified examples of the embodiments. The processor 105 stores the decoded video data in the memory unit 103, displays the decoded video data through the user interface unit 101, or outputs the decoded video data to a different device via the communication interface unit 102.

The computer program possible to perform the function of each unit of the video encoding apparatus 10 on the processor may be provided in the form of being recorded in a computer-readable medium. Similarly, the computer program possible to perform the function of each unit of the video decoding apparatus 20 on the processor may be provided in the form of being recorded in a computer-readable medium. Note that such a recording medium does not include any carrier wave.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A video encoding apparatus that performs inter-predictive coding on a plurality of field pictures included in a video, the video encoding apparatus comprising:
a buffer memory that stores an encoded field picture among the plurality of field pictures;
a controller that adds reference pair information to each of the plurality of field pictures when a frame picture is to be created by interleaving two field pictures forming a pair, the reference pair information specifying a different field picture to form the pair;
a buffer interface that generates, when inter-predictive coding is performed by using, as a coding target picture, a frame picture created by interleaving two field pictures that are not encoded among the plurality of field pictures, a frame picture as a reference picture by interleaving the field pictures of the pair specified with reference to the reference pair information of an encoded field picture stored in the buffer memory;
an encoder that generates, when the coding target picture is a frame picture, encoded data by performing inter-predictive coding on the coding target picture on a frame-picture-by-frame-picture basis by use of the reference picture; and
an entropy encoder that performs entropy coding on the encoded data and the reference pair information to generate encoded video data including the entropy-encoded reference pair information.

2. The video encoding apparatus according to claim 1, further comprising a reference picture management unit that determines the encoded field picture to be stored in the buffer memory on the basis of a structure of a coding unit to which the coding target picture belongs and a coding order of the coding target picture, creates reference picture information indicating a field picture usable as the reference picture among the encoded field picture stored in the buffer memory, and notifies the encoder of the reference picture information,
wherein the encoder notifies the buffer interface of information specifying an encoded field picture to be used as the reference picture stored in the buffer memory on the basis of the reference picture information.

3. The video encoding apparatus according to claim 2, wherein the controller
calculates, with respect to two field pictures consecutive in terms of time among the plurality of field pictures, a moving amount of an object captured in the two field pictures, and
when the moving amount is smaller than a first threshold value, notifies the encoder that a frame picture created by interleaving the two field pictures is to be used as the coding target picture, while notifying, when the moving amount is larger than or equal to the first threshold value, the encoder that the two field pictures are used as individual coding target pictures.

4. The video encoding apparatus according to claim 3, wherein
the controller
calculates a moving amount of an object captured in each two field pictures that are included in the coding unit and are consecutive in a display order, and
sets, when an average moving amount obtained by averaging the moving amounts of the entire coding unit is smaller than a second threshold value, a coding order for each pair of two field pictures being consecutive in the display order, with respect to respective field pictures included in the coding unit, while setting, when the average moving amount is larger than or equal to the second threshold value, a coding order for each field picture included in the coding unit.

5. A video decoding apparatus that decodes an encoded video including a plurality of field pictures which are inter-predictive encoded, the video decoding apparatus comprising:
an entropy decoder that decodes entropy-encoded data on a decoding target picture and reference pair information specifying, for each of the plurality of field pictures, when a frame picture is to be created by interleaving two field pictures forming a pair, a different field picture to form the pair;
a buffer memory that stores a decoded field picture among the plurality of field pictures;
a reference picture management unit that determines, when the decoding target picture is a frame picture created by interleaving two field pictures that are not decoded among the plurality of field pictures, two decoded field pictures to be used for generating a reference picture, with reference to the reference pair information;
a buffer interface that generates a frame picture as the reference picture, when inter-predictive decoding is performed by using, as the decoding target picture, a frame picture created by interleaving two field pictures that are not decoded among the plurality of field pictures, by interleaving two decoded field pictures determined on the basis of the reference pair information from among decoded field pictures stored in the buffer memory; and
a decoder that decodes, when the decoding target picture is a frame picture, the decoding target picture by performing inter-predictive decoding on the encoded data on the decoding target picture on a frame-picture-by-frame-picture basis by use of the reference picture.

6. A video encoding method for performing inter-predictive coding on a plurality of field pictures included in a video, the video encoding method comprising:
storing, by a processor, an encoded field picture among the plurality of field pictures in a buffer memory;
adding reference pair information to each of the plurality of field pictures when a frame picture is to be created by interleaving two field pictures forming a pair, the reference pair information specifying a different field picture to form the pair;
generating, by the processor, when inter-predictive coding is performed by using, as a coding target picture, a frame picture created by interleaving two field pictures that are not encoded among the plurality of field pictures, a frame picture as a reference picture by interleaving the field pictures of the pair specified with reference to the reference pair information of an encoded field picture stored in the buffer memory;
generating, by the processor, when the coding target picture is a frame picture, encoded data by performing inter-predictive coding on the coding target picture on a frame-picture-by-frame-picture basis by use of the reference picture; and
performing, by the processor, entropy coding on the encoded data and the reference pair information to generate encoded video data including the entropy-encoded reference pair information.

7. The video encoding method according to claim 6, further comprising:
determining, by the processor, the encoded field picture to be stored in the buffer memory on the basis of a structure of a coding unit to which the coding target picture belongs and a coding order of the coding target picture;
creating, by the processor, reference picture information indicating a field picture usable as the reference picture among the encoded field picture stored in the buffer memory; and
specifying, by the processor, an encoded field picture to be used as the reference picture stored in the buffer memory on the basis of the reference picture information.

8. The video encoding method according to claim 7, further comprising:
calculating, by the processor, with respect to two field pictures consecutive in terms of time among the plurality of field pictures, a moving amount of an object captured in the two field pictures; and
determining, by the processor, a frame picture created by interleaving the two field pictures as the coding target picture when the moving amount is smaller than a first threshold value, while determining the two field pictures as individual coding target picture when the moving amount is larger than or equal to the first threshold value.

9. The video encoding method according to claim 8, further comprising:
calculating, by the processor, a moving amount of an object captured in each two field pictures that are included in the coding unit and are consecutive in a display order; and
setting, by the processor, a coding order for each pair of two field pictures being consecutive in the display order, with respect to respective field pictures included in the coding unit when an average moving amount obtained by averaging the moving amounts of the entire coding unit is smaller than a second threshold value, while setting a coding order for each field picture included in the coding unit, when the average moving amount is larger than or equal to the second threshold value.

10. A video decoding method for decoding an encoded video including a plurality of field pictures which are inter-predictive encoded, the video decoding method comprising:
decoding entropy-encoded data on a decoding target picture and reference pair information specifying, for each of the plurality of field pictures, when a frame picture is to be created by interleaving two field pictures forming a pair, a different field picture to form the pair;
storing a decoded field picture among the plurality of field pictures in a buffer memory;
determining, when the decoding target picture is a frame picture created by interleaving two field pictures that are not decoded among the plurality of field pictures, two decoded field pictures to be used for generating a reference picture, with reference to the reference pair information;
generating a frame picture as the reference picture, when inter-predictive decoding is performed by using, as the decoding target picture, a frame picture created by interleaving two field pictures that are not decoded among the plurality of field pictures, by interleaving two decoded field pictures determined on the basis of the reference pair information from among decoded field pictures stored in the buffer memory; and
decoding, when the decoding target picture is a frame picture, the decoding target picture by performing inter-predictive decoding on the encoded data on the decoding target picture on a frame-picture-by-frame-picture basis by use of the reference picture.
